(19) United States
(12) Patent Application Publication
(10) Pub. No.: US 2014/0321317 A1
(43) Pub. Date: Oct. 30, 2014

(54) METHOD, APPARATUS, AND COMPUTER PROGRAM PRODUCT FOR NETWORK TYPE DETERMINATION

(71) Applicant: NOKIA CORPORATION, Espoo (FI)

(72) Inventors: Mika KASSLIN, Espoo (FI); Janne MARIN, Espoo (FI); Enrico RANTALA, Iittala (FI); Markku TURUNEN, Helsinki (FI)

(73) Assignee: Nokia Corporation, Espoo (FI)

(21) Appl. No.: 13/871,154

(22) Filed: Apr. 26, 2013

(51) Int. Cl. H04W 48/16; H04W 56/00; H04W 4/00

(52) U.S. Cl. CPC H04W 48/16; H04W 4/008; H04W 56/001
USPC 370/254

(57) ABSTRACT

Method, apparatus, and computer program product example embodiments enable access to a wireless communications medium. In example embodiments, a method comprises receiving, by an apparatus, one or more wireless communications message frames including at least a dedicated a network type identifier that identifies an associated network type comprising at least one of a synchronized contention group and an isolated contention group; and determining, by the apparatus, the network type of a wireless communications network associated with the one or more wireless communication message frames, based on the received network type identifier.

### FIELD

The field of the invention relates to wireless short-range communication and more particularly to determination of a type of a wireless communications medium.

### BACKGROUND

Modern society has adopted, and is becoming reliant upon, wireless communication devices for various purposes, such as, connecting users of the wireless communication devices with other users. Wireless communication devices can vary from battery powered handheld devices to household and/or commercial devices utilizing electrical network as a power source. Due to rapid development of the wireless communication devices a number of areas capable of enabling entirely new types of communication applications have emerged.

Cellular networks facilitate communication over large geographic areas. These network technologies have commonly been divided by generations, starting in the late 1970s to early 1980s with first generation (1G) analog cellular telephones that provided baseline voice communications, to modern digital cellular telephones. GSM is an example of a widely employed 2G digital cellular network communicating in the 900 MHZ/1.8 GHZ bands in Europe and at 850 MHz and 1.9 GHZ in the United States. While long-range communication networks, such as GSM, are a well-accepted means for transmitting and receiving data, due to cost, traffic and legislative concerns, these networks may not be appropriate for all data applications.

Short-range communication technologies provide communication solutions that avoid some of the problems seen in large cellular networks. Bluetooth™ is an example of a short-range wireless technology quickly gaining acceptance in the marketplace. In addition to Bluetooth™ other popular short-range communication technologies include Bluetooth™ Low Energy, IEEE 802.11 wireless local area network (WLAN), Wireless USB (WUSB), Ultra Wide-band (UWB), ZigBee (IEEE 802.15.4, IEEE 802.15.4a), and ultra-high frequency radio frequency identification (UHF RFID) technologies. All of these wireless communication technologies have features that make them appropriate for various applications.

Applications for short-range wireless devices are evolving to include awareness applications providing the device with an awareness about the local network environment. Awareness applications have the promise of extending business and social networking by enabling users to share local contextual data in a peer-to-peer fashion by using their mobile wireless devices. For example, users may be able to share information in real-time for local-area business networking, social networking, dating, personal safety, advertising, publishing, and searching.

### SUMMARY

Method, apparatus, and computer program product example embodiments enable determination of a type of a wireless communications medium.

According to an example embodiment of the invention, a method comprises:

receiving, by an apparatus, one or more wireless communications message frames including at least a dedicated a network type identifier that identifies an associated network type comprising at least one of a synchronized contention group and an isolated contention group; and

determining, by the apparatus, the network type of a wireless communications network associated with the one or more wireless communication message frames, based on the received network type identifier.

According to an example embodiment of the invention, a method comprises:

wherein the determined network type of the wireless communications network comprises a synchronized contention group and the apparatus currently operates in an existing contention group of the wireless communications network;

determining, by the apparatus, that the received one or more wireless communications message frames is from a foreign contention group in the wireless communications network and that the one or more wireless communications message frames include a received time value different from a local time value in the apparatus; and

deciding, by the apparatus, to adopt the discovery window schedule of the foreign contention group based on the received time value.

According to an example embodiment of the invention, a method comprises:

transmitting, by the apparatus, one or more synchronization frames to the existing contention group, when the apparatus moves its operations to the foreign contention group, the one or more synchronization frames including information about the foreign contention group, to enable wireless devices in the existing contention group to adopt the discovery window schedule of the foreign contention group.

According to an example embodiment of the invention, a method comprises:

wherein when the received time value is larger than the local time value, the discovery window schedule of the foreign contention group is adopted.

According to an example embodiment of the invention, a method comprises:

wherein the determined network type of the wireless communications network comprises an isolated contention group and the apparatus currently operates in an existing contention group of the wireless communications network;

determining, by the apparatus, that the received one or more wireless communications message frames is from a foreign contention group in the wireless communications network and that the one or more wireless communications message frames include a received time value different from a local time value in the apparatus; and

deciding, by the apparatus, to adopt the discovery window schedule of the foreign contention group based on the received time value.

According to an example embodiment of the invention, a method comprises:

ceasing, by the apparatus, operations in the existing contention group of which it has been a member, and immediately starting operations in the foreign contention group when the apparatus is moving its operations to the foreign contention group.

According to an example embodiment of the invention, a method comprises:

executing, by an apparatus, a programmed application that determines a network type for a wireless communications network associated with the apparatus, based on an active requirement associated with the apparatus; and

commanding, by the apparatus, a protocol stack in the apparatus, to operate the wireless communications network comprising at least one of a synchronized contention group and an isolated contention group, in response to the determined network type.

According to an example embodiment of the invention, an apparatus comprises:

at least one processor;

at least one memory including computer program code;

the at least one memory and the computer program code configured to, with the at least one processor, cause the apparatus at least to:

receive one or more wireless communications message frames including at least a dedicated a network type identifier that identifies an associated network type comprising at least one of a synchronized contention group and an isolated contention group; and

determine the network type of a wireless communications network associated with the one or more wireless communication message frames, based on the received network type identifier.

According to an example embodiment of the invention, an apparatus comprises:

wherein the determined network type of the wireless communications network comprises a synchronized contention group and the apparatus currently operates in an existing contention group of the wireless communications network;

the at least one memory and the computer program code configured to, with the at least one processor, cause the apparatus at least to:

determine that the received one or more wireless communications message frames is from a foreign contention group in the wireless communications network and that the one or more wireless communications message frames include a received time value different from a local time value in the apparatus; and

decide to adopt the discovery window schedule of the foreign contention group based on the received time value.

According to an example embodiment of the invention, an apparatus comprises:

the at least one memory and the computer program code configured to, with the at least one processor, cause the apparatus at least to:

transmit one or more synchronization frames to the existing contention group, when the apparatus moves its operations to the foreign contention group, the one or more synchronization frames including information about the foreign contention group, to enable wireless devices in the existing contention group to adopt the discovery window schedule of the foreign contention group.

According to an example embodiment of the invention, an apparatus comprises:

wherein when the received time value is larger than the local time value, the discovery window schedule of the foreign contention group is adopted.

According to an example embodiment of the invention, an apparatus comprises:

wherein the determined network type of the wireless communications network comprises an isolated contention group and the apparatus currently operates in an existing contention group of the wireless communications network;

the at least one memory and the computer program code configured to, with the at least one processor, cause the apparatus at least to:

determine that the received one or more wireless communications message frames is from a foreign contention group in the wireless communications network and that the one or more wireless communications message frames include a received time value different from a local time value in the apparatus; and

decide to adopt the discovery window schedule of the foreign contention group based on the received time value.

According to an example embodiment of the invention, an apparatus comprises:

the at least one memory and the computer program code configured to, with the at least one processor, cause the apparatus at least to:

cease operations in the existing contention group of which it has been a member, and immediately starting operations in the foreign contention group when the apparatus is moving its operations to the foreign contention group.

According to an example embodiment of the invention, an apparatus comprises:

at least one processor;

at least one memory including computer program code;

the at least one memory and the computer program code configured to, with the at least one processor, cause the apparatus at least to:

execute a programmed application that determines a network type for a wireless communications network associated with the apparatus, based on an active requirement associated with the apparatus; and

command a protocol stack in the apparatus, to operate the wireless communications network comprising at least one of a synchronized contention group and an isolated contention group, in response to the determined network type.

According to an example embodiment of the invention, a computer program product comprises computer executable program code recorded on a computer readable non-transitory storage medium, the computer executable program code comprising:

code for receiving, by an apparatus, one or more wireless communications message frames including at least a dedicated a network type identifier that identifies an associated network type comprising at least one of a synchronized contention group and an isolated contention group; and

code for determining, by the apparatus, the network type of a wireless communications network associated with the one or more wireless communication message frames, based on the received network type identifier.

According to an example embodiment of the invention, a computer program product comprises:

wherein the determined network type of the wireless communications network comprises a synchronized contention group and the apparatus currently operates in an existing contention group of the wireless communications network;

code for determining, by the apparatus, that the received one or more wireless communications message frames is from a foreign contention group in the wireless communications network and that the one or more wireless communications message frames include a received time value different from a local time value in the apparatus; and

code for deciding, by the apparatus, to adopt the discovery window schedule of the foreign contention group based on the received time value.

According to an example embodiment of the invention, a computer program product comprises:

code for transmitting, by the apparatus, one or more synchronization frames to the existing contention group, when the apparatus moves its operations to the foreign contention group, the one or more synchronization frames including information about the foreign contention group, to enable wireless devices in the existing contention group to adopt the discovery window schedule of the foreign contention group.

According to an example embodiment of the invention, a computer program product comprises:

wherein when the received time value is larger than the local time value, the discovery window schedule of the foreign contention group is adopted.

According to an example embodiment of the invention, a computer program product comprises:

wherein the determined network type of the wireless communications network comprises an isolated contention group and the apparatus currently operates in an existing contention group of the wireless communications network;

code for determining, by the apparatus, that the received one or more wireless communications message frames is from a foreign contention group in the wireless communications network and that the one or more wireless communications message frames include a received time value different from a local time value in the apparatus; and

code for deciding, by the apparatus, to adopt the discovery window schedule of the foreign contention group based on the received time value.

According to an example embodiment of the invention, a computer program product comprises:

code for ceasing, by the apparatus, operations in the existing contention group of which it has been a member, and immediately starting operations in the foreign contention group when the apparatus is moving its operations to the foreign contention group.

According to an example embodiment of the invention, a computer program product comprises:

code for executing, by an apparatus, a programmed application that determines a network type for a wireless communications network associated with the apparatus, based on an active requirement associated with the apparatus; and

code for commanding, by the apparatus, a protocol stack in the apparatus, to operate the wireless communications network comprising at least one of a synchronized contention group and an isolated contention group, in response to the determined network type.

The resulting example embodiments enable determination of a type of a wireless communications medium.

### DESCRIPTION OF THE FIGURES

FIG. 1A illustrates an example network diagram of an ad hoc neighbor awareness network (NAN) type: Synchronized Cells. The cells are also referred to as contention groups or beacon groups. The network type determines whether discovery window schedules are aligned across cell borders (network of synchronized cells) or whether discovery window schedules are localized to each cell, with the objective to keep adjacent/overlapping cells unsynchronized in their discovery windows, in accordance with at least one embodiment of the present invention.

FIG. 1B illustrates the example network diagram of FIG. 1A, of the ad hoc neighbor awareness network (NAN) type: Synchronized Cells. The wireless device 100A joins the beacon group 10Y and adopts its discovery window schedule WY, in accordance with at least one embodiment of the present invention.

FIG. 1C illustrates the example network diagram of FIG. 1B, of the ad hoc neighbor awareness network (NAN) type: Synchronized Cells. The wireless device 100A decides to join the older beacon group 10X that has a discovery window schedule WX, in accordance with at least one embodiment of the present invention.

FIG. 1D illustrates the example network diagram of FIG. 1C, of the ad hoc neighbor awareness network (NAN) type: Synchronized Cells. In a network of synchronized cells 10X and 10Y, the objective is to maximize use of one and the same discovery window schedule. When a NAN wireless device 100A operates in a network of synchronized cells, if the wireless device 100A is a master device in the current/old cell 10Y, the device transmits as a master device in the current/old cell 10Y at least one sync frame or beacon 140A that contains information about the new cell 10X, including the discovery window schedule WX of the new cell 10X. Once the wireless device 100A has transmitted at least one sync frame or beacon 140A in the current/old cell 10Y with information about the new cell 10X, it may start operating in the new cell 10X and ceases all the operations in the old cell 10Y. Once the wireless devices 100D, 100E and 100F have received a beacon 140A from the wireless device 100A with the information about the new cell 10X, the three wireless devices 100D, 100E and 100F also synchronize to the discovery window schedule WX of the new cell 10X, in accordance with at least one embodiment of the present invention.

FIG. 1E illustrates the example network diagram of FIG. 1D, of the ad hoc neighbor awareness network (NAN) type: Synchronized Cells. The wireless device 100A receives a beacon 140C from device 100C in the older beacon group 10X and joins to the older beacon group. Once the wireless devices 100D, 100E and 100F have received the beacon 140A from the wireless device 100A with the information about the new cell 10X, the three wireless devices 100D, 100E and 100F synchronize to the discovery window schedule WX of the new cell 10X, in accordance with at least one embodiment of the present invention.

FIG. 1F illustrates an example timing diagram of the Synchronized Cells NAN type network, wherein the wireless device 100F in the cell 10Y has received the beacon 140A from the wireless device 100A with the information about the new cell 10X, and synchronizes its discovery window schedule to the discovery window schedule WX of the new cell 10X, in accordance with an example embodiment of the invention.

FIG. 2A illustrates an example network diagram of an ad hoc neighbor awareness network (NAN) type: Isolated Cells. The wireless device 100A begins scanning for beacons, in accordance with at least one embodiment of the present invention.

FIG. 2B illustrates the example network diagram of FIG. 2A, of the ad hoc neighbor awareness network (NAN) type: Isolated Cells. The wireless device 100F in the younger beacon group 10Y transmits a beacon that is received by wireless devices 100A, 100D, and 100E. The wireless device 100A joins the beacon group 10Y, in accordance with at least one embodiment of the present invention.

FIG. 2C illustrates the example network diagram of FIG. 2B, of the ad hoc neighbor awareness network (NAN) type: Isolated Cells. The wireless device 100A decides to join the older beacon group 10X, in accordance with at least one embodiment of the present invention.

FIG. 2D illustrates the example network diagram of FIG. 2C, of the ad hoc neighbor awareness network (NAN) type: Isolated Cells. When a NAN wireless device 100A operates in a network of isolated cells, then when moving its operations to a new cell 10X, regardless of whether the wireless device 100A is a master or a non-master device in the current/old cell 10Y, it starts operating in the new cell 10X and ceases all the operations in the old cell 10Y. The discovery window schedule WY of the wireless devices 100A, 100D, and 100E in the current/old cell 10Y, remains unchanged, in accordance with at least one embodiment of the present invention.

FIG. 3 is an example functional block diagram of the wireless device 100A operating in a network of synchronized cells and moving from current/old cell 10Y to new cell 10X, in accordance with at least one embodiment of the present invention.

FIG. 4A is an example flow diagram of operational steps in the wireless device 100A of FIG. 1A, in accordance with at least one embodiment of the present invention.

FIG. 4B is an example flow diagram of operational steps in any of the wireless devices 100A, 100B, 100C, 100D, 100E, and 100F in network 5 of FIG. 1A through FIG. 1E or any of the wireless devices 100A, 100B, 100C, 100D, 100E, and 100F in network 5′ of FIG. 2A through FIG. 2D, in accordance with at least one embodiment of the present invention.

FIG. 5 shows an example format of a beacon packet transmitted by wireless device 100A that includes information about the new cell 10X, in accordance with at least one embodiment of the present invention.

FIG. 6 illustrates an example embodiment of the invention, wherein examples of removable storage media are shown, based on magnetic, electronic and/or optical technologies, such as magnetic disks, optical disks, semiconductor memory circuit devices and micro-SD memory cards (SD refers to the Secure Digital standard) for storing data and/or computer program code as an example computer program product, in accordance with an example embodiment of the invention.

### DISCUSSION OF EXAMPLE EMBODIMENTS OF THE INVENTION

This section is organized into the following topics:

A. WLAN Communication Technology

B. Awareness Network Technology

C. Network Type Determination

A. WLAN Communication Technology

The IEEE 802.11 standard specifies methods and techniques of an exemplary wireless local area network (WLAN) operation. Examples include the IEEE 802.11b and 802.11g wireless local area network specifications, which have been a staple technology for traditional WLAN applications in the 2.4 GHz ISM band. The various amendments to the IEEE 802.11 standard were consolidated for IEEE 802.11a, b, d, e, g, h, i, j, k, n, r, s, u, v, and z protocols, into the base standard IEEE 802.11-2012, Wireless Medium Access Control (MAC) and Physical Layer (PHY) Specifications, February 2012. Since then, emerging broadband applications have stimulated interest in developing very high-speed wireless networks for short range communication, for example, the planned IEEE 802.11 ac, and the planned IEEE 802.11 ad WLAN specifications that are to provide a very high throughput in various frequency bands. Applications of these IEEE 802.11 standards include products such as consumer electronics, telephones, personal computers, and access points for both for home and office.

A WLAN may be organized as an independent basic service set (IBSS) or an infrastructure basic service set (BSS). Wireless devices or stations (STAs) in an independent basic service set (IBSS) communicate directly with one another and there is no access point in the IBSS. WLAN ad hoc networks have an independent configuration where the mobile devices communicate directly with one another, without support from a fixed access point. WLAN ad hoc networks support distributed activities similar those of the Bluetooth™ piconets. The IEEE 802.11 standard provides wireless devices with service inquiry features similar to the Bluetooth™ inquiry and scanning features.

The independent basic service set (IBSS) has a BSS Identifier (BSSID) that is a unique identifier for the particular ad hoc network. Its format is identical to that of an IEEE 48-bit address. In an ad hoc network, the BSSID is a locally administered, individual address that is generated randomly by the device that starts the ad hoc network.

Synchronization is the process of the devices in an ad hoc network getting in step with each other, so that reliable communication is possible. The MAC provides the synchronization mechanism to allow support of physical layers that make use of frequency hopping or other time-based mechanisms where the parameters of the physical layer change with time. The process involves beaconing to announce the presence of an ad hoc network, and inquiring to find an ad hoc network. Once an ad hoc network is found, a device joins the ad hoc network. This process is entirely distributed in ad hoc networks, and relies on a common time base provided by a timing synchronization function (TSF). The TSF may maintain a 64-bit timer running at 1 MHz and updated by information from other devices. When a device begins operation, it may reset the timer to zero. The timer may be updated by information received in beacon frames.

Each wireless device or STA maintains a TSF timer with modulus 2⁶⁴ counting in increments of microseconds. STAs expect to receive Beacon frames at a nominal rate. The interval between Beacon frames is defined by a Beacon Period parameter of the STA. A STA sending a Beacon frame sets the value of the Beacon frame's timestamp so that it equals the value of the STA's TSF timer at the time that the data symbol containing the first bit of the timestamp is transmitted to the PHY plus the transmitting STA's delays through its local PHY from the MAC-PHY interface to its interface with the antenna or light-emitting diode (LED) emission surface.

In an ad hoc network, since there is no access point (AP) to act as the central time source for the ad hoc network, the timer synchronization mechanism is completely distributed among the mobile devices of the ad hoc network. Since there is no AP, the mobile device that starts the ad hoc network will begin by resetting its TSF timer to zero and transmitting a Beacon, choosing a beacon period. This establishes the basic beaconing process for this ad hoc network. After the ad hoc network has been established, each device in the ad hoc network will attempt to send a Beacon after the target beacon transmission time (TBTT) arrives. To minimize actual collisions of the transmitted Beacon frames on the medium, each device in the ad hoc network may choose a random delay value which it may allow to expire before it attempts its beacon transmission.

Once a device has performed an inquiry that results in one or more ad hoc network descriptions, the device may choose to join one of the ad hoc networks. The joining process is a purely local process that occurs entirely internal to the mobile device. There is no indication to the outside world that a device has joined a particular ad hoc network. Joining an ad hoc network may require that all of the mobile device's MAC and physical parameters be synchronized with the desired ad hoc network. To do this, the device may update its timer with the value of the timer from the ad hoc network description, modified by adding the time elapsed since the description was acquired. This will synchronize the timer to the ad hoc network. The BSSID of the ad hoc network may be adopted, as well as the parameters in the capability information field. Once this process is complete, the mobile device has joined the ad hoc network and is ready to begin communicating with the devices in the ad hoc network.

There are three major types of medium access control (MAC) frames in the IEEE 802.11 protocol: the management frame, the control frame, and the data frame. Management frames provide management services. Data frames carry payload data. Control frames assist in the delivery of data and management frames. Each of these types of MAC frame consists of a MAC header, a frame body, and a frame check sequence (FCS). The header contains control information used for defining the type of 802.11 MAC frame and providing information necessary to process the MAC frame. The frame body contains the data or information included in either management type or data type frames. The frame check sequence is a value representing a cyclic redundancy check (CRC) over all the fields of the MAC header and the frame body field.

1. Beacon

The beacon frame is a management frame that is transmitted periodically to allow mobile devices to locate and identify an ad hoc network. Beacon generation in an IBSS is distributed. The value of the beacon period is included in Beacon and Probe Response frames, and devices or STAs adopt that beacon period when joining the IBSS. All members of the IBSS participate in beacon generation. Each STA maintains its own TSF timer that is used for Beacon Period timing. The beacon interval within an IBSS is established by the STA when the START request primitive is performed within a device to create the IBSS. This defines a series of target beacon transmission times (TBTT) exactly a Beacon Period apart, which is the time at which an ad hoc device must send a beacon. Time zero is defined to be a TBTT. At each TBTT the STA waits for the random backoff interval and then sends a Beacon frame if the random delay has expired and no other Beacon frame has arrived from the IBSS of which the STA is a member during the delay period.

The beacon frame includes the fields: timestamp, beacon interval, and capability information. The timestamp contains the value of the device's synchronization timer (TSF) at the time that the frame was transmitted. The capability information field is a 16-bit field that identifies the capabilities of the device. The information elements in a beacon frame are the service set identifier (SSID), the supported rates, one or more physical parameter sets, an optional contention-free parameter set, an optional ad hoc network parameter set, and an optional traffic indication map. There is no restriction on the format or content of the 32 byte SSID.

The first ad hoc device to become active establishes an IBSS and starts sending beacons that to maintain synchronization among the devices. Other ad hoc devices may join the network after receiving a beacon and accepting the IBSS parameters, such as the beacon interval, found in the beacon frame.

Each device that joins the ad hoc network may send a beacon periodically if it doesn't hear a beacon from another device within a short random delay period after the beacon is supposed to be sent. If a device doesn't hear a beacon within the random delay period, then the device assumes that no other devices are active and a beacon needs to be sent. A beacon signal is periodically transmitted from the ad hoc network. The beacon frame is transmitted periodically and includes the address of the sending device.

2. Probe Request

The probe request frame is a management frame that is transmitted by a mobile device attempting to quickly locate a wireless LAN. It may be used to locate a wireless LAN with a particular SSID or to locate any wireless LAN. The probe request frame may contain the service attribute request. The effect of receiving a probe request is to cause the device to respond with a probe response. When a wireless device arrives within the communication range of any member of an ad hoc network, its probe request frame inquiry signals are answered by a member of the ad hoc network detecting the inquiry. A device in an ad hoc network responds to the probe request frame inquiry signals with a probe response containing the address of the responding device. The probe response frame also includes the timestamp, beacon interval, capability information, information elements of the SSID, supported rates, one or more physical parameter sets, the optional contention-free parameter set, and the optional ad hoc network parameter set.

For active scans, the WLAN radio may broadcast a probe request on the medium it is scanning using a broadcast SSID in the probe request. The WLAN radio will add any received beacons or probe responses to a cached basic service set identifier (BSSID) scan list. For passive scans, the WLAN radio does not send a probe request, but instead, listens on a medium for a period of time and adds any received beacons or probe responses to its cached BSSID scan list. The WLAN radio may scan both infrastructure and ad hoc networks, regardless of the current setting of its network mode. The WLAN radio may use either the active or passive scanning methods, or a combination of both scanning methods. When performing an active scan, the WLAN radio sets the BSSID to the broadcast MAC address in the probe request it sends. The WLAN radio performs the scan across all the frequency mediums and bands that it supports.

3. Probe Response

Devices or STAs in an IBSS respond to probe requests if it is awake at a given time to receive and respond to the probe requests. In an IBSS, a STA that sent a Beacon frame remains in the Awake state and responds to probe requests, until a Beacon frame with the current BSSID is received. There may be more than one STA in an IBSS that responds to any given probe request, particularly in cases where more than one STA transmitted a Beacon frame following the most recent TBTT, either due to not receiving successfully a previous Beacon frame or due to collisions between beacon transmissions. In an IBSS, STAs receiving Probe Request frames respond with a probe response when the SSID in the probe request is the wildcard SSID or matches the specific SSID of the STA. In an IBSS a STA that transmitted a Beacon frame since the last TBTT responds to group addressed Probe Request frames. A STA in an IBSS responds to Probe Request frames sent to the individual address of the STA. Probe Response frames are sent as directed frames to the address of the STA that generated the probe request.

4. Carrier Sense Multiple Access with Collision Avoidance (CSMA/CA)

According to an example embodiment, the IEEE 802.11 WLAN may use two types of transmission: Distributed Coordination Function (DCF) and Point Coordination Function (PCF). DCF employs Carrier Sense Multiple Access with Collision Avoidance (CSMA/CA). A packet sent may be positively acknowledged by the receiver. A transmission may begin with a Request to Send (RTS) and the receiver may respond with a Clear to Send (CTS). The channel may be cleared by these two messages, since all STAs that hear at least one of the CTS and the CTS may suppress their own start of a transmission. The Request to Send (RTS) packet sent by the sender and the Clear to Send (CTS) packet sent in reply by the intended receiver, may alert all other devices within range of the sender or the receiver, to refrain from transmitting for the duration of the main packet.

According to an example embodiment, when data packets are transmitted, each may have a Network Allocation Vector (NAV) containing a duration value to reserve the channel for the sender and receiver for an interval after the current packet, equal to the NAV duration. The network allocation vector (NAV) is an indicator that may be maintained by each STA, of time periods when transmission onto the wireless medium will not be initiated by the STA whether or not the STA's physical carrier sensing function senses that the medium is busy. Use of the NAV for carrier sensing is called virtual carrier sensing. STAs receiving a valid frame may update their NAV with the information received in the duration field for all frames where the new NAV value is greater than the current NAV value, including the RTS and CTS packets, as well data packets. The value of the NAV decrements with the passage of time. Once the sender and receiver have reserved the channel, they may hold it for the remaining duration of the NAV value. The last acknowledgement packet (ACK) contains a NAV value of zero, to release the channel.

In a block acknowledgement (BA), instead of transmitting an individual ACK for every MAC protocol data unit (MPDU), multiple MPDUs may be acknowledged together using a single BA frame. Block Ack (BA) contains bitmap size of 64*16 bits. Each bit of this bitmap represents the success or failure status of a MPDU.

According to an example embodiment, standard spacing intervals are defined in the IEEE 802.11 specification, which delay a station's access to the medium, between the end of the last symbol of the previous frame and the beginning of the first symbol of the next frame. The short interframe space (SIFS), the shortest of the interframe spaces, may allow acknowledgement (ACK) frames and clear to send (CTS) frames to have access to the medium before others. The longer duration distributed coordination function (DCF) interframe space (IFS) or DIFS interval may be used for transmitting data frames and management frames.

According to an example embodiment, after the channel has been released, IEEE 802.11 wireless devices normally employ a spectrum sensing capability during the SIFS interval or DIFS interval, to detect whether the channel is busy. A carrier sensing scheme may be used wherein a node wishing to transmit data has to first listen to the channel for a predetermined amount of time to determine whether or not another node is transmitting on the channel within the wireless range. If the channel is sensed to be idle, then the node may be permitted to begin the transmission process. If the channel is sensed to be busy, then the node may delay its transmission for a random period of time called the backoff interval. In the DCF protocol used in IEEE 802.11 networks, the stations, on sensing a channel idle for DIFS interval, may enter the backoff phase with a random value between 0 and CWmin. The backoff counter may be decremented from this selected value as long as the channel is sensed idle.

According to an example embodiment, an algorithm, such as binary exponential backoff, may be used to randomly delay transmissions, in order to avoid collisions. The transmission may be delayed by an amount of time that is the product of the slot time and a pseudo random number. Initially, each sender may randomly wait 0 or 1 slot times. After a busy channel is detected, the senders may randomly wait between from 0 to 3 slot times. After the channel is detected to be busy a second time, the senders may randomly wait between from 0 to 7 slot times, and so forth. As the number of transmission attempts increases, the number of random possibilities for delay increases exponentially. An alternate backoff algorithm is the truncated binary exponential backoff, wherein after a certain number of increases, the transmission timeout reaches a ceiling and thereafter does not increase any further.

According to an example embodiment, it may also be possible to start data transmission directly without RTS-CTS signaling and in that case, the first packet carries information similar to the RTS to start protection.

IEEE 802.11 wireless devices normally employ Carrier Sense Multiple Access (CSMA), wherein a spectrum sensing capability is used during an interval like the SIFS interval, DIFS interval or AIFS interval, to detect whether the channel is busy. A carrier sensing scheme may be used wherein a node wishing to transmit data has to first listen to the channel for a predetermined amount of time to determine whether or not another node is transmitting on the channel within the wireless range. If the channel is sensed to be idle, then the node may be permitted to begin the transmission process. If the channel is sensed to be busy, then the node may delay its transmission for a random period of time called the backoff interval. In the DCF protocol used in IEEE 802.11 networks, the stations, on sensing a channel idle for DIFS interval, may enter the backoff phase with a random value between 0 and CWmin. The backoff counter may be decremented from this selected value as long as the channel is sensed idle. Binary exponential backoff may be used to randomly delay transmissions, in order to avoid collisions. The transmission may be delayed by an amount of time that is the product of the slot time and a pseudo random number. Initially, each sender may randomly wait 0 or 1 slot times. After a busy channel is detected, the senders may randomly wait between from 0 to 3 slot times. After the channel is detected to be busy a second time, the senders may randomly wait between from 0 to 7 slot times, and so forth. As the number of transmission attempts increases, the number of random possibilities for delay increases exponentially.

The mobile device that starts an ad hoc network will begin by resetting its TSF timer to zero and transmitting a Beacon, choosing a beacon period, which establishes the basic beaconing process for this ad hoc network. After the ad hoc network has been established, each device in the ad hoc network will attempt to send a Beacon after the target beacon transmission time (TBTT) arrives, choosing a random delay value to avoid collisions. Each device in a beacon group receives a beacon including timing synchronization of the beacon group of which the device is a member. The synchronized devices in the beacon group should be simultaneously available during a discovery interval to listen for and to exchange messages. Discovery intervals may be aligned with TBTTs. The beginning of a discovery interval may be aligned with a TBTT or alternatively, a discovery interval may be deemed to start upon reception or transmission of a beacon after a TBTT.

5. Synchronization

Synchronization is the process of the devices in an ad hoc network getting in step with each other, so that reliable communication is possible. The MAC may provide the synchronization mechanism to allow support of physical layers that make use of frequency hopping or other time-based mechanisms where the parameters of the physical layer change with time. The process may involve beaconing to announce the presence of an ad hoc network, and inquiring to find an ad hoc network. Once an ad hoc network is found, a device may join the ad hoc network. This process may be entirely distributed in ad hoc networks, and may rely on a common timebase provided by a timer synchronization function (TSF). The TSF may maintain a 64-bit timer running at 1 MHz and updated by information from other devices. When a device begins operation, it may reset the timer to zero. The timer may be updated by information received in beacon frames.

Since there is no AP, the mobile device that starts the ad hoc network may begin by resetting its TSF timer to zero and transmitting a beacon, choosing a beacon period. This establishes the basic beaconing process for this ad hoc network. After the ad hoc network has been established, each device in the ad hoc network will attempt to send a beacon after the target beacon transmission time (TBTT) arrives. To minimize actual collisions of the transmitted beacon frames on the medium, each device in the ad hoc network may choose a random delay value which it may allow to expire before it attempts its beacon transmission.

Once a device has performed an inquiry that results in one or more ad hoc network descriptions, the device may choose to join one of the ad hoc networks. The joining process may be a purely local process that occurs entirely internal to the mobile device. There may be no indication to the outside world that a device has joined a particular ad hoc network. Joining an ad hoc network may require that all of the mobile device's MAC and physical parameters be synchronized with the desired ad hoc network. To do this, the device may update its timer with the value of the timer from the ad hoc network description, modified by adding the time elapsed since the description was acquired. This will synchronize the timer to the ad hoc network. The BSSID of the ad hoc network may be adopted, as well as the parameters in the capability information field. Once this process is complete, the mobile device has joined the ad hoc network and is ready to begin communicating with the devices in the ad hoc network.

6. Quality of Service (QoS)

The Quality of Service (QoS) support in the IEEE 802.11 WLAN protocol is provided by access categories (ACs) and multiple independent backoff entities. The Quality of Service (QoS) support defines the MAC procedures to support local area network (LAN) applications with quality of service (QoS) requirements, including the transport of voice, audio, and video.

Packets are delivered by parallel backoff entities operating within the same WLAN device, where backoff entities are prioritized using AC-specific contention parameters. There are four access categories (ACs) and thus, four backoff entities exist in every WLAN device. The AC-specific contention parameters are labeled according to their target application: AC_VO for voice or audio packets, AC_VI for video packets, AC_BE for packets whose delivery is on a best effort basis, and AC_BK for background packets. The four access categories (ACs) define the priorities in accessing the medium by setting individual interframe spaces, contention windows, and other medium access parameters per access category (AC).

Contention-based medium access is performed in every backoff entity by using different parameter values for the AC-specific contention parameters. The AC-specific contention parameters are announced via information fields in beacon frames. The same AC-specific contention parameters are used by the backoff entities different WLAN devices in the network.

Each backoff entity within a WLAN device independently contends for a transmit opportunity (TXOP) of a packet. It starts down-counting the backoff-counter after detecting the medium being idle for a duration defined by the arbitration interframe space (AIFS) that is based on the value of the AC-specific contention parameter of the packet to be transmitted. The arbitration interframe space (AIFS) defines the earliest access time that the WLAN device may transmit the packet. Voice packets that have the AC-specific contention parameter AC_VO and video packets that have the AC-specific contention parameter AC_VI have a high value for access priority. Best effort basis packets that have the AC-specific contention parameter AC_BE have a medium value for access priority. Background packets that have the AC-specific contention parameter AC_BK have a low value for access priority.

The minimum size of the contention window, CWmin, for transmission of a packet, is another parameter dependent on the AC-specific contention parameter. The smaller the CWmin, the higher the priority of the packet for accessing the medium. Voice packets that have the AC-specific contention parameter AC_VO have the smallest contention window whereas background packets that have the AC-specific contention parameter AC_BK have the longest contention window.

B. Awareness Network Technology

Applications for short-range wireless devices are evolving to include awareness applications providing the device with an awareness about the local network environment. A non-limiting example awareness network architecture is the Nokia AwareNet framework, a network of wireless mobile devices self-organizing to support various applications, ranging from social networking to service discovery. Awareness information may be shared by a short-range wireless device sending an anonymous flooding message that may include a query, over an ad hoc network. A neighboring short-range wireless device may reply to the flooding message over the ad hoc network with a response, such as a pointer to a discovered location-based service.

Awareness information may include any information and/or context about a local network environment as well as the users and communication devices within the local network environment. Wireless devices may continuously collect and exchange information with other devices in a local network environment. Awareness applications running on short-range wireless devices may create a network for sharing awareness information, locate and organize awareness information, form communities for sharing awareness information, manage power consumption for devices engaged in sharing awareness information, develop applications to take advantage of the awareness information, and maintain the privacy and anonymity of users sharing awareness information.

Awareness applications running on short-range wireless devices, build upon a scheme in which every device is responsible for participating in beaconing and all the other basic operations that keep the ad hoc network in operation. An ad hoc network may be designed to have one network identifier (NWID) that all of the devices in the network share. The NWID may be announced in the beacons transmitted by the devices. In the overall design, those devices that operate under same NWID are driven to use a common and shared schedule to allow for awareness information gathering among all the devices within range. The determination of which schedule is used by a device may be made by the network instance timer value, and this timer value is communicated in beacons in the timing synchronization function (TSF) value parameter. The devices may be required to operate by assuming the oldest TSF value (i.e. largest TSF value) contained in the received beacons that represent the network with the NWID in which the devices are operating. Alternatively the devices may be required to select the schedule which to follow based on some other criteria than the TSF value. Beacons may, as an example, contain some other information than the TSF that is used by the devices to determine which schedule to use.

When the radio and MAC of a wireless device transmits a Beacon, the Beacon MAC-header contains device's own current TSF value. The device may automatically transmit a reply message when it receives a Beacon from another network, the reply message being referred herein as a beacon response message. The beacon response message contains the current TSF value of the replying network. Alternatively the beacon response message may contain other information that is used to determine which schedule to use.

Wireless devices form a network where all devices in proximity may communicate with each other. When two or more groups of devices forming two or more instances of the network come close to each other, the two or more instances may merge to become one network instance. Devices may make a merging or join decision to change the instance autonomously based on the TSF information collected from Beacons received during scan periods or based on the TSF information collected from received beacon response messages. A merging decision may be performed when a device receives a Beacon or beacon response message with an older (greater) TSF value from another wireless device. Alternatively a merging decision may be done based on some other information available in a Beacon or beacon response message from another wireless device. After the merging decision has been performed by a device, the device moves into the new network instance.

The awareness functionality in a short-range wireless device may be divided between four layers in the awareness architecture. The Awareness Layer and the Community Layer provide services for applications, i.e. provide the awareness API. The approximate functional split between the different layers is as follows.

Awareness Layer

According to an embodiment, Awareness Layer (AwL) has the highest level of control of the awareness architecture. Example services the AwL offers to the applications comprise Publish and Subscribe. The Awareness Layer receives publish and subscribe requests from applications and maps these into queries and query responses that, in turn, are mapped as awareness messages, the Network Layer PDU, that traverse from device to device. It also maps the awareness messages received by the device, to the application. The network layer does not appear as a data pipe for applications. A single awareness message is self-contained and short, the AwL compresses the messages in order for them to consume as little resources as possible.

The Awareness Layer may comprise an internal storage of awareness data items. Publishing an item normally means storing it in this internal storage (passive publish). Such an item is visible to other devices in the local vicinity and may be found using the Subscribe service. It is also possible to use active publishing that causes the Awareness Layer to issue a publish message that propagates from device to device. It is the responsibility of the AwL to decide whether a received message leads to the notification of an application (filtering). Items may be marked to be visible to only certain communities, so that they are visible only to searches made by members of such a community.

The Subscribe request causes the Awareness Layer to issue either a single or repetitive query message(s) that eventually propagate to other devices in the local vicinity (by using the functionality of lower awareness layers). When such a query message reaches the AwL of a device that happens to possess a matching information item, it responds with a reply message. The lower layers of awareness architecture take care of the routing of such a message back to the AwL of the querying device, which notifies the application of the other device that issued the Subscribe request.

Community Layer

The concept of communities has been integrally built into awareness architecture. Awareness communication may be visible to all the devices, or just to those that belong to a certain community. Regardless of this visibility, all wireless devices take part in the routing of messages. The role of the Community Layer (CoL) is to implement the community visibility rules. Only those messages that a certain device has visibility to (i.e. a device belongs to the same community as the message) are passed to the AwL. As an additional level of community privacy, messages are encrypted by the Community Layer. To allow such message filtering and encryption/decryption, the CoL stores the community credentials for those communities to which the user of the device belongs. The default awareness community (all local users) does not use any credentials and therefore its messages simply pass through the Community Layer.

According to an example embodiment, Awareness architecture comprises three different kinds of communities: the default awareness community, peer communities and personal communities. Communities may also be categorized with their privacy. Messages of public communities are transmitted as plain text whereas messages of private communities are transmitted encrypted. The default awareness community is the default community for all wireless devices. Awareness community messages are not encrypted and every node may send and receive awareness community messages (public community). In a peer community all members are equal and every member may receive all the community specific messages. A peer community may be public, or it may be private meaning that community messages are encrypted using a temporary key derived from the community specific shared key. The encryption function may be based on Advanced Encryption Standard, EAX mode (AES/EAX) with 128 bit keys. A personal community has a community owner that manages the community. A non-owner community member may communicate with the owner but not with other members of the community. A personal community is private, meaning that community messages from the owner to other members may be encrypted.

Network Layer

The Network Layer (NL) takes care of the local dissemination of the awareness messages. This is accomplished by way of a smart-flooding algorithm that attempts to adapt to the surrounding device density. At high densities, very few devices participate in the transmission of a given message. At low densities, all the devices may retransmit each message (normal flooding). The awareness network has a flat hierarchy; none of the devices may assume any special roles. Thus, at high densities, all the devices will transmit approximately the same amount of traffic (no clustering). The Network layer may also take care of the routing of the replies back to the device that issued the search. To this end, it collects routing information from the messages that flow through it. It also keeps track of all the neighbors and their approximate distance. Normally, reply routing uses unicast transmissions, whereas flooding messages are always broadcasted. All the messages received by the Network Layer are passed to Community Layer in order to check whether the message should be processed in the AwL.

Link Layer

Link Layer performs the adaptation between the underlying radio technology (e.g. IEEE 802.11 WLAN physical layer) and the Network Layer. It maps the specific information of the radio technology, such as radio identifiers and received signal strengths, into technology neutral information used by the Network Layer (NL). Multiple Link Layer instances may be used by the NL, e.g. for simultaneous usage of different radio technologies.

The Link Layer may be divided into two sub layers: logical link control (LLC) and media access control (MAC). LLC provides radio technology agnostic service for the Network Layer. It hides differences between radio technology specific MACs. LLC provides a single service access point for the Network layer. LLC knows how to map the generic provided service to the service provided by the technology specific MACs. The LLC internal data structures include the Neighbor Table that contains information of all the neighboring devices that have been heard in the recent past.

The Link Layer tries to transmit data via the given medium using the TransmitData functionality. Transmission may succeed or it may fail. Internally the Link Layer may try transmissions several times if a medium is temporarily busy. The Link Layer passes all the messages it receives to the Network Layer. This also includes unicast messages that are intended for other nodes.

The logical link control (LLC) is aware of radio technology specific MACs. In case of the IEEE 802.11 WLAN MAC example, the LLC does the following WLAN MAC specific actions:
Control (Reset, Configure) WLAN MAC.
Decide when to merge WLAN networks.
Construct a message package to be sent to WLAN MAC from outgoing messages.
Select which messages are to be sent and which are ignored immediately, e.g. if there are too many messages to be sent.
Extract incoming data messages contained in reception reports.
Update the Neighbor Table when reception reports and scan reports are received.

Merging of WLAN networks may be the responsibility of the logical link control (LLC). The LLC may determine when to merge two WLAN network instances or beacon groups as a single larger network instance or a beacon group. LLC may calculate an estimate of its own WLAN network size. Estimation may be based on information provided by the Network Layer, information found in the LLC Neighbor Table and network size category shared by other nodes. A network size category is calculated from an estimated network size.

The IEEE 802.11 WLAN MAC awareness mode enables a wireless device to use its power efficiently. In the awareness mode, the WLAN radio is asleep most of the time, thus reducing power consumption. Messages are transmitted and received in a batch mode, i.e. LLC passes all the messages that the MAC is to transmit during a single awake period, in a single package. The MAC passes all the messages received during a single awake period in a single reception report. The LLC collects messages to be transmitted in a single package. When the MAC is awake, the LLC passes the package to the MAC and it tries to transmit the messages. When the MAC is about to go asleep, it sends a transmission report to the LLC containing information about messages it has succeeded to transmit and about messages it has failed to transmit. In addition MAC passes a reception report to LLC. The report contains messages received during the awake period.

According to an embodiment, the merging or joining process is a purely local process that occurs entirely internally to the wireless device. There is no indication to the outside world that a device has joined a particular ad hoc network. Joining an ad hoc network may require that all of the mobile device's MAC and physical parameters be synchronized with the desired ad hoc network. To do this, the device may update its timer with the TSF value of the timer from the ad hoc network description, modified by adding the time elapsed since the description was acquired. This will synchronize the device's timer to the ad hoc network. The BSSID of the ad hoc network may be adopted, as well as the parameters in the capability information field. Once this process is complete, the wireless device has joined the ad hoc network and is ready to begin communicating with the wireless devices in the ad hoc network.

The IEEE 802.11 WLAN MAC awareness mode provides the following functionalities:
Reset MAC.
Configure MAC.
Join a WLAN network or create a new network.
Join an existing WLAN network (BSSID is known).
Set a template for beacon frames so that LLC parameters can be passed in WLAN beacon frames.
Try to transmit a set of messages.
Receive a set of incoming messages.
Receive a set of WLAN scan messages

Message Propagation

According to an embodiment, the propagation of an awareness search message is conducted in the awareness architecture layers of different devices. An application initiates a subscription in the device by using the Subscribe service offered by the Awareness Layer. The Awareness Layer realizes the subscription by sending a query message to other devices. In all the devices the message goes at least up to the Community Layer. However, only in those devices that belong to the community to which the message was intended, does the message proceed to the AwL. There is no need to have an application present in the replying device. It is sufficient to only have the awareness platform active.

C. Network Type Determination

In accordance with an example embodiment, the invention may be used in the logical architecture of the Neighbor Awareness Networking (NAN) program being standardized by the Wi-Fi Alliance (WFA). The NAN protocol stack is expected to comprise of two components: 1) NAN Discovery Engine, 2) MAC with NAN support. MAC with NAN support provides means for NAN devices to synchronize in time and frequency to provide common availability periods for service discovery frames from/to the NAN Discovery Engine.

NAN Discovery Engine

The NAN Discovery Engine provides Publish and Subscribe services to the applications for service discovery purposes.

Publishing is the ability to make application-selected information about e.g. capabilities and services available for other NAN devices that seek information with Subscribing, using protocols and mechanisms certified by the Neighbor Awareness Networking program. NAN devices that use Publishing may provide published information in an unsolicited or solicited manner.

Subscribing is the ability to discover information that has been made available in other NAN devices with Publishing, using protocols and mechanisms certified by the Neighbor Awareness Networking program. NAN devices that use Subscribing may passively listen for or actively seek published information.

An application may request Publish and Subscribe services to run in a certain type of NAN network, in any type of NAN network, or in all types of NAN networks. The NAN network type selection determines whether the discovered Publish and Subscribe services are intended to happen in isolated cells, among the NAN devices that are close by, or among all the NAN devices that are within range of the NAN device. Network type selection, per NAN Discovery Engine service, is reflected in the lower levels of the NAN stack, handling the NAN network and cell selection functions. When a Publish/Subscribe service has been configured to run in one type of network, corresponding functionality and discovery protocol message exchanges are made to happen only in a network of the same type.

Publish and Subscribe services are expected to exploit a discovery protocol that the NAN Discovery Engine implements and which is designed for NAN. The protocol is expected to have three different protocol messages: 1) Discovery query message, 2) Discovery response message, and 3) Discovery announcement message. The Subscribe service is expected to use the Discovery query message to conduct active discovery. The Subscribe service may be configured to operate in passive mode only. In this mode, no Discovery query messages are transmitted, but one listens for Discovery responses and Discovery announcement messages to find the information sought. The Publishing service is expected to use the Discovery response message and Discovery announcement message to announce availability of application-selected information to discovering devices. The Discovery response message is intended to be used as a response to a received Discovery query that meets response criteria. The Discovery announcement message is intended to be used to implement unsolicited Publishing service.

A device in which the Subscribe service has been activated in active mode, transmits Discovery query messages to trigger Publishing devices to transmit Discovery response messages. In parallel, the Subscribing device monitors received Discovery responses and Discovery announcement messages to determine the availability of services and information being sought. Monitoring is envisioned to be a continuous process that applies to all Discovery response and Discovery announcement messages received while the Subscribe service is active. With this approach, a Subscribing device may gather valuable information from Discovery responses and from Discovery announcement messages that are independent from its own Discovery query message transmissions.

MAC with NAN Support

The MAC is responsible for acquiring and maintaining time and frequency synchronization among devices that are close by, so that the devices are available for discovery protocol message exchange in same channel at same time. Synchronization happens through dedicated synchronization frames that are transmitted by so called master devices (on default) at the beginning of the availability periods. Sync frames are transmitted periodically in certain channels. Periodicity and channel usage is determined by sync frame parameters. Each device needs to be capable of acting as a master device and each device is expected to determine for each availability period whether it is a master device or not. This determination is done through a master election algorithm. The synchronization frames determine the schedule (time and frequency) of both the synchronization frame transmissions and the availability periods or discovery windows.

A NAN network is comprised of a set of NAN devices that operate under a common network identifier (NAN ID) and that share common sync frame and discovery window parameters. A NAN network comprises of one or more NAN cells. Each NAN cell may be a contention group or beacon group and may be considered a local representation of a NAN network. A NAN cell is comprised of a set of NAN devices that operate in a NAN network with one NAN ID and which are synchronized with respect to both the sync frame transmissions and the discovery windows. In order for NAN devices to form a NAN cell, at least some of them need to be within range of each other. The NAN ID is carried at least in synchronization frames that may be of a beacon frame format. Each beacon contains a NAN ID field that is used in a NAN device receiving a beacon, to determine, as an example, whether the beacon is from a NAN network in which the NAN device is operating and from what type of NAN network the beacon was transmitted. In one embodiment of the invention, the NAN ID is a numerical value that is indicated with a 6-octet field in beacons or in synchronization frames used in the NAN networks, to provide basic synchronization within NAN cells. In one embodiment of the invention, there is no NAN cell identifier that would be carried in beacon frames, but NAN cells are differentiated with different schedules especially from perspective of sync frame (beacon) schedule.

Basic Principles of NAN Operations:
Upon activating the NAN functions in a device, the device first looks for a NAN network by means of passive discovery. The NAN functions are activated by an application in the device requesting either the Subscribe or the Publish service to be activated, when there is no service active in the NAN Discovery Engine.
   a) On default there is at least one NAN ID that is determined in a NAN specification and the NAN device looks for such a network and its cells.
Joining a NAN network/NAN cell: If the device finds at least one NAN cell that the device may join, the device selects a cell and joins it. If the device finds no NAN cell that the device may join, the device establishes a NAN cell of its own. An application may have also requested the Publish service to be activated in a passive mode. In such case the device doesn't ever establish a NAN cell, but it only operates in NAN cells that have been established by others.
   a) A NAN device may join a NAN cell when the following criterion is met:
      1. The device receives at least one sync frame from the cell with signal level exceeding a pre-determined threshold RSSI_C (e.g. −50 dBm).
Upon joining a NAN cell a NAN device synchronizes itself both to the sync frame transmission and discovery window schedule of the cell.
   a) Additionally, the device is responsible for running the master election algorithm to determine whether it is a master device that is responsible for transmitting a sync frame.
Once in a NAN cell, a NAN device may continue operating in it, as long as one of the following criteria is met:
   a) The device receives at least one sync frame from the cell with signal level exceeding a pre-determined threshold RSSI_C (e.g. −50 dBm).
   b) The device operates as a master device transmitting sync frames.
When operating in a NAN cell, a NAN device is responsible for maintaining both the base clock of the cell by transmitting sync frames as needed and the discovery window schedule of the cell.
Additionally, a NAN device is responsible for conducting passive discovery once a while to figure out whether there are other NAN cells within range that that the device should consider joining
   a) When a NAN device detects a sync frame of a NAN cell different from the one in which the device operates, but both the cells belong to the NAN network the device operates in, and the sync frame is received with signal level exceeding a pre-determined threshold RSSI_C (e.g. −50 dBm), the device proceeds as follows:
      1. If the timestamp (e.g. TSF value) in the sync frame from the foreign cell is larger than the time in one's own cell, the device moves its operations to the foreign cell.
      2. Otherwise the device continues its operations in the current cell.

Neighbor Awareness Networking Network
A NAN network is comprised of a set of NAN devices that operate under a common network identifier (NAN ID) and that share common sync frame and discovery window parameters.
A NAN network is comprised of one or more NAN cells.
In accordance with an example embodiment of the invention, two NAN network types are defined:
   a) Network of synchronized cells.
   b) Network of isolated cells.
Network identifier (NAN ID) depends on the network type.
   a) In a preferred implementation the NAN specification determines at least two NAN ID values and for each ID value the specification also determines the network type.
The network type determines whether discovery window schedules are aligned across cell borders (network of synchronized cells) or whether discovery window schedules are local to the cell with the objective to especially keep adjacent/overlapping cells unsynchronized from the perspective of discovery windows.
   a) In a network of synchronized cells, the objective is to maximize use of one and same discovery window schedule.
   b) In a network of isolated cells, the objective is to keep the cells operating with their own discovery window schedules, so that only those devices that operate in same cell are available for NAN discovery frames at a same time, in a same channel.

Cell

A set of NAN devices that operate in a NAN network with one NAN ID and that are synchronized with respect to both the sync frame transmissions and the discovery windows form a NAN cell.

In order for NAN devices to form a NAN cell, at least some of them need to be within range of each other.

Synchronization within a NAN cell means that the devices share the burden of sync frame transmission and are available simultaneously for NAN discovery during discovery windows.

Depending on whether a cell belongs to a network of synchronized cells or to a network of isolated cells, the NAN devices moving from a cell to another have certain obligations that are discussed in more detail later.

Sync Frames

Sync frames form the basis of time and frequency synchronization in the NAN network. All the NAN devices are responsible for participating in sync frame transmission, as per master role selection rules.

Sync frames are transmitted as per sync frame parameters that determine how often and in which channel(s) the frames are transmitted.

Sync frames provide a base clock for NAN devices and the base clock is used as the reference when specifying the discovery window schedule.

The base clock builds upon the time synchronization function (TSF) that is used in WLAN, and each sync frame is expected to contain a TSF timestamp value indicator.

A sync frame may be realized as a Beacon frame.

Discovery Window

A discovery window is a time period during which NAN devices are available for NAN discovery frame exchange.

Discovery windows happen as per discovery window parameters that determine how often and in which channel(s) the windows happen.

Discovery window schedule builds upon the information available in sync frames.

Discovery window schedule may be NAN cell specific or same across NAN cell borders depending on the NAN network type.

Device Operations in a NAN Network

Upon activating the NAN in a device, the device first looks for a NAN network by means of passive discovery.

On default, there is one default NAN ID that is determined in a NAN specification and the NAN device looks for such a network and its cells.

Joining a NAN network/NAN cell:

If the device finds at least one NAN cell that the device may join, the device selects a cell and joins it.

If the device finds no NAN cell that the device may join, the device establishes a NAN cell of its own. If the NAN Discovery Engine has been requested to activate the Subscribe service in a passive mode, the device may also decide not to establish a NAN cell of its own, but it only operates in NAN cells it discovers.

When a NAN device operates in a NAN cell, it periodically conducts passive discovery to find out whether other NAN cells of the NAN network in which the device operates, are available.

Joining a NAN Cell

A NAN device may join a NAN cell when the following criterion is met:
The device receives at least one sync frame from the cell with signal level exceeding a pre-determined threshold RSSI_C (e.g. −50 dBm).

Upon joining a NAN cell, a NAN device synchronizes itself both to the sync frame transmission and discovery window schedule of the cell.

Additionally, the device is responsible for running the master election algorithm to determine whether it is a master device that is responsible for transmitting a sync frame.

Operating in a NAN Cell

A NAN device may continue operating in a NAN cell as long as one of the following criteria is met:
The device receives at least one sync frame from the cell with signal level exceeding a pre-determined threshold RSSI_C (e.g. −50 dBm).
The device operates as a master device transmitting sync frames.

When operating in a NAN cell, a NAN device is responsible for maintaining both the base clock of the cell by transmitting sync frames as needed, and the discovery window schedule of the cell.

Master Election

In accordance with an example embodiment of the invention, a node, device, or STA may operate in one of two roles: As a Master Sync STA, it competes with other Master STAs to transmit a Beacon. As a Non-Master Sync STA, it does not compete to transmit a Beacon. The Master Sync STA role may be determined by the Master Election Algorithm for Neighbor Awareness Networking. Every node, device, or STA of an ad hoc network may need to be able to operate in both roles and the Master Election Algorithm may need to be run by every node, device, or STA once in a while or periodically.

A NAN device that operates in a NAN cell may need to be responsible for determining for each discovery window, as per the master election algorithm, whether it is a master device.

A Sync Frame from a Foreign Cell

When a NAN device detects a sync frame of a NAN cell different from the one in which the device operates, but both the cells belong to the NAN network the device operates in, and the sync frame is received with signal level exceeding a pre-determined threshold RSSI_C (e.g. −50 dBm), the device proceeds as follows:
If the timestamp (e.g. TSF value) in the sync frame from the foreign cell is larger than the time in one's own cell, the device moves its operations to the foreign cell.
Alternatively some other information in the sync frame from the foreign cell is analyzed to determine whether the device moves its operations to the foreign cell.
Otherwise the device continues its operations in the current cell.

Moving Operations to a New Cell

When a NAN device operates in a network of synchronized cells, it shall do as follows when moving its operations to a new cell upon detecting the existence of the new cell through passive discovery:
a) If the device is a master device in the current/old cell, the rules are as follows:
   The device transmits as a master device in the current/old cell at least one sync frame that contains information about the new cell. This includes information at least about TSF value and discovery window schedule of the new cell.
   Once the device has transmitted at least one sync frame in the current/old cell with information about the new cell, it shall start operating in the new cell and ceases all the operations in the old cell.
b) If the device is a non-master device in the current/old cell, the rules are as follows:
   The device shall start operating in the new cell and ceases all the operations in the old cell.

When a NAN device operates in a network of isolated cells, it shall do as follows when moving its operations to a new cell:
a) Regardless of whether the device is a master or a non-master device in the current/old cell, the device shall start operating in the new cell and ceases all the operations in the old cell.

Aligning Discovery Window Schedules

When a NAN device operates in a network of synchronized cells, it shall do as follows upon detecting the existence of the new cell from a received sync frame that contains information about the new cell and the new cell is indicated to be the one whose discovery window is to be used:
a) If the device is a master device in the current/old cell, the rules are as follows:
   The device may transmit as a master device in the current/old cell at least one sync frame that contains information about the new cell.
   The device starts using the discovery window schedule of the new cell.
   The device may activate passive discovery to find out whether it can detect the new cell and whether it can receive sync frames from the new cell with high enough signal level in order to synchronize from perspective of sync frame transmissions.
b) If the device is a non-master device in the current/old cell, the rules are as follows:
   The device starts using the discovery window schedule of the new cell.
   The device may activate passive discovery to find out whether it can detect the new cell and whether it can receive sync frames from the new cell with high enough signal level in order to synchronize from perspective of sync frame transmissions.

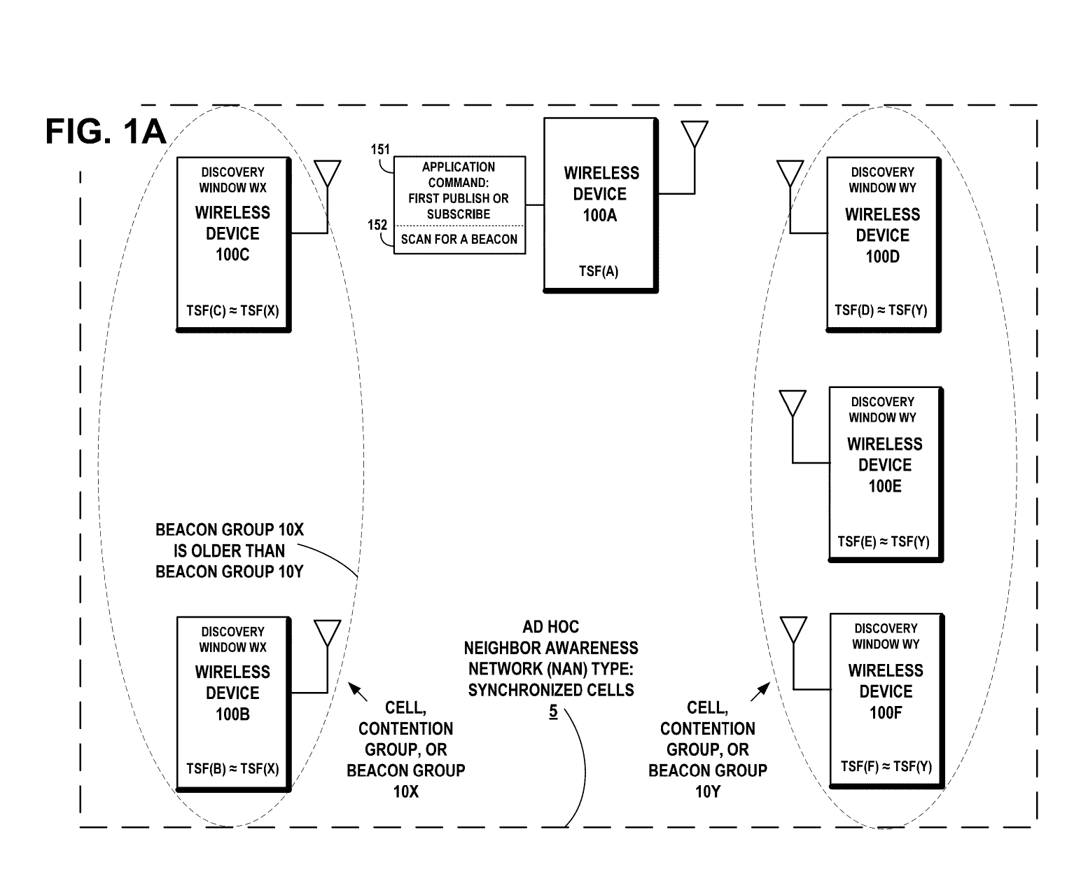

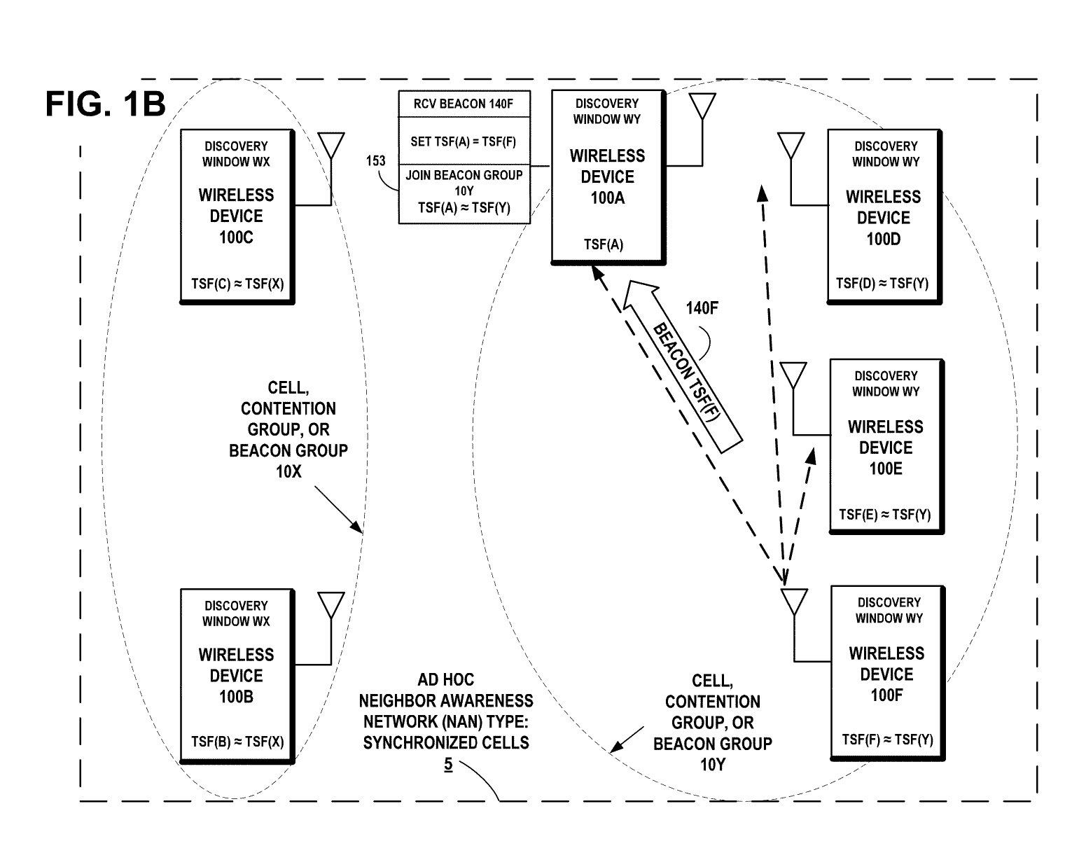

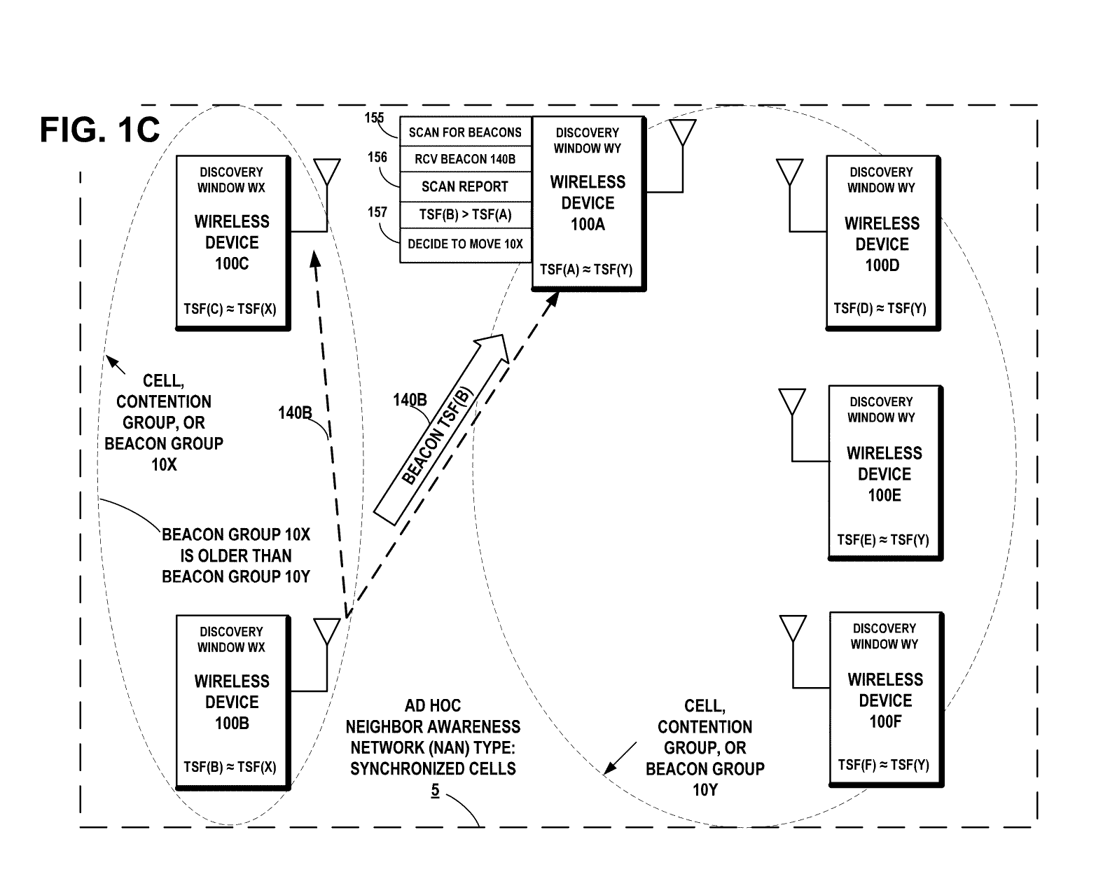

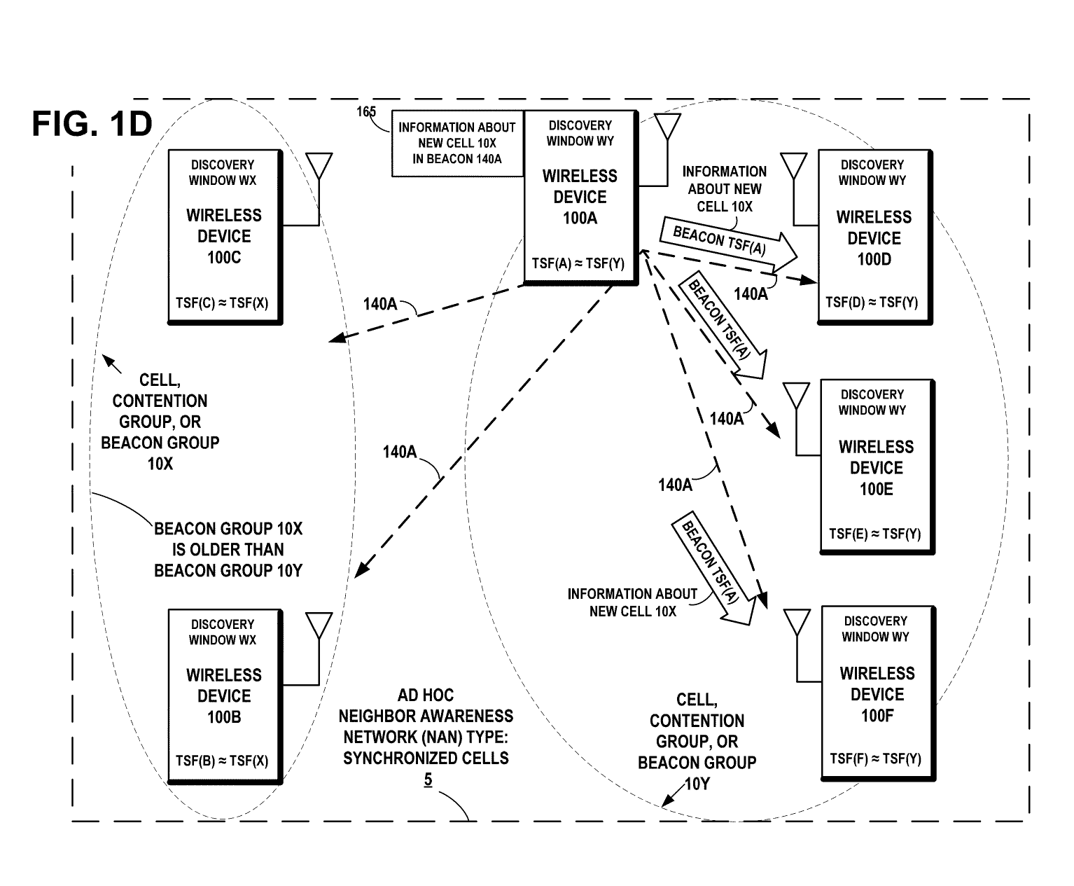

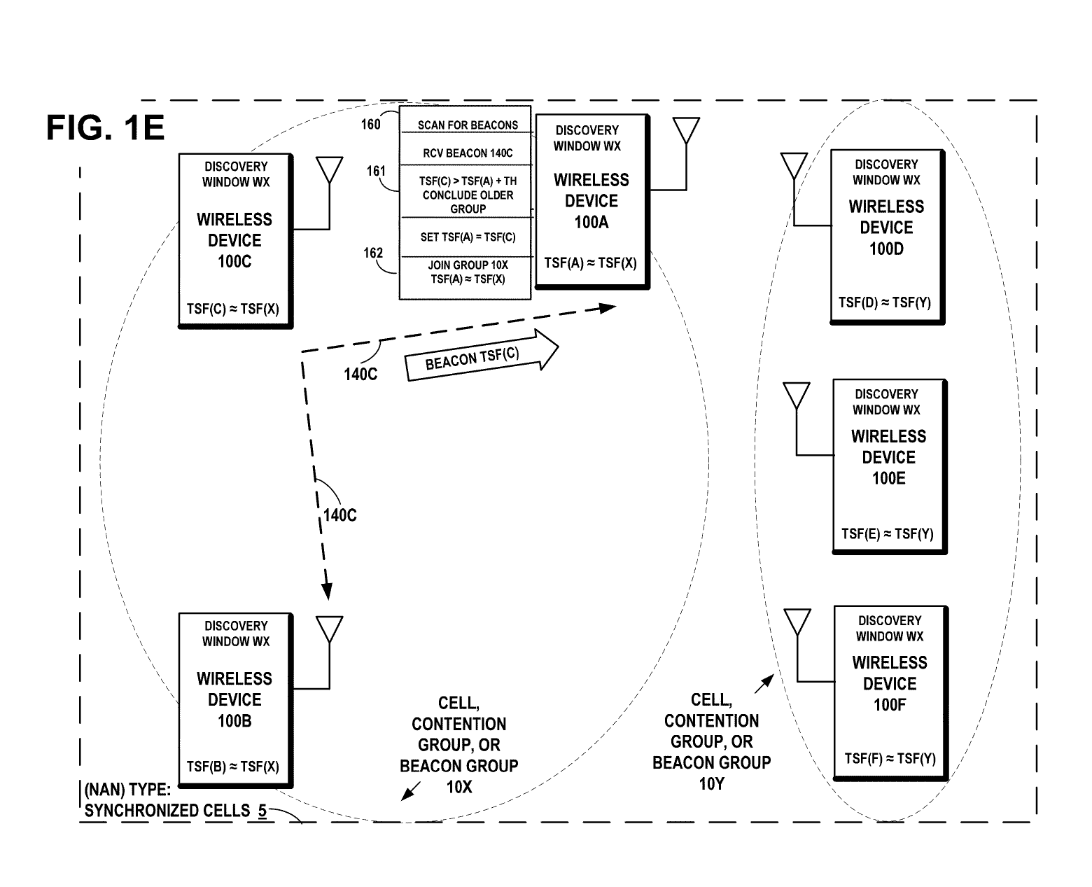

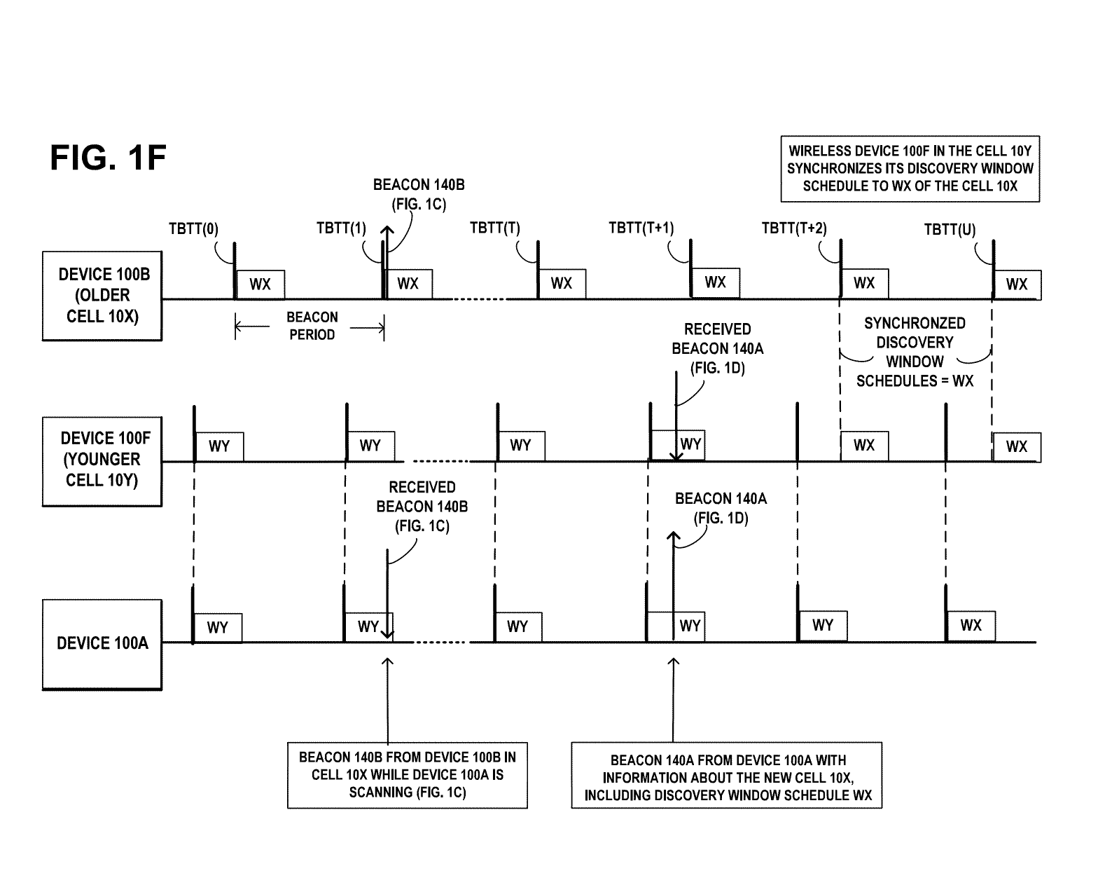

FIG. 1A illustrates an example network diagram of an ad hoc neighbor awareness network (NAN) type: Synchronized Cells. The cells are also referred to as contention groups or beacon groups. The network type determines whether discovery window schedules are aligned across cell borders (network of synchronized cells) or whether discovery window schedules are localized to each cell, with the objective to keep adjacent/overlapping cells unsynchronized. The network 5 includes two ad hoc cells, contention groups, or beacon groups, one an older beacon group 10X that has a discovery window schedule WX and the other a younger beacon group 10Y that has a discovery window schedule WY. All wireless devices in proximity within a beacon group may communicate with each other. Beacons transmitted in the beacon groups contain NAN network identifier that also indicate the type of the network to which the beacon group belongs. An application in wireless device 100A commands the NAN Discovery Engine in the device to start either the Subscribe or the Publish service. As part of such a command, the application running in the device may indicate the type of the NAN network to which the service is targeted. If the NAN Discovery Engine has no previous Subscribe or Publish service active for the requested network type, the device begins looking for beacons, in accordance with at least one embodiment of the present invention. When the command has contained an indication of the targeted network type, the device looks for beacons from NAN cells of the indicated network type. In the illustrated example case, the command has been to start one of the NAN Discovery Engine services in a network of synchronized cells.

FIG. 1B illustrates the example network diagram of FIG. 1A, of the ad hoc neighbor awareness network (NAN) type: Synchronized Cells. The wireless device 100F in the younger beacon group 10Y transmits a beacon 140F that is received by wireless devices 100A, 100D, and 100E. The wireless device 100A sets its timing synchronization function TSF(A) to the value of TSF(F) in the received beacon, adopts its discovery window schedule WY, and joins the beacon group 10Y, as indicated at 153, in accordance with at least one embodiment of the present invention.

FIG. 1C illustrates the example network diagram of FIG. 1B, of the ad hoc neighbor awareness network (NAN) type: Synchronized Cells. The wireless device 100A is looking for beacons, as indicated at 155. Wireless device 100B in the older beacon group 10X transmits a beacon 140B that is received by wireless device 100A. The beacon packet 140B may include the NAN ID of cell 10X, the beacon period of the new cell 10X, the timestamp TSF(B) of wireless device 100B, and the discovery window schedule WX of the cell 10X. The wireless device 100A compares its time synchronization function TSF(A) that approximates the TSF(Y) of the younger beacon group 10Y, with the value of TSF(B) in the received beacon, which approximates the TSF(X) of the older beacon group 10X. The wireless device 100A determines that the beacon group 10X is older than its existing beacon group 10Y. The wireless device 100A decides to move its operations to the older beacon group 10X, as indicated at 157, and adopt its discovery window schedule WX, in accordance with at least one embodiment of the present invention.

FIG. 1D illustrates the example network diagram of FIG. 1C, of the ad hoc neighbor awareness network (NAN) type: Synchronized Cells. In a network of synchronized cells 10X and 10Y, the objective is to maximize use of one and the same discovery window schedule. When a NAN wireless device 100A operates in a network of synchronized cells, if the wireless device 100A is a master device in a cell 10Y, the device transmits as a master device in the cell 10Y at least one sync frame or beacon 140A that contains information about the new cell 10X. The information indicates at least the TSF value and the discovery window schedule WX of the new cell 10X. The beacon packet 140A may include the NAN ID of new cell 10X, the beacon period of the new cell 10X, the timestamp TSF(X) of the new cell 10X, and the discovery window schedule WX of the new cell 10X. Once the wireless device 100A has transmitted at least one sync frame or beacon 140A in the cell 10Y with information about the new cell 10X, it may start operating in the new cell 10X and cease all the operations in the old cell 10Y. Once the wireless devices 100D, 100E and 100F have received a beacon 140A from the wireless device 100A with the information about the new cell 10X, the three wireless devices 100D, 100E and 100F also synchronize their discovery window schedules with the discovery window schedule WX of new cell 10X. Alternately, if the wireless device 100A were a non-master device in the cell 10Y, then the device starts operating in the new cell 10X and ceases all the operations in the old cell 10Y. Additionally, the wireless devices 100D, 100E and 100F in the younger beacon group 10Y may also join the older beacon group 10X with respect to beacon schedule, in accordance with at least one embodiment of the present invention. Whether the devices 100D, 100E and 100F join the foreign cell 10X and move their operations to the foreign beacon group, depends on how strongly they hear beacons from the foreign cell.

FIG. 1E illustrates the example network diagram of FIG. 1D, of the ad hoc neighbor awareness network (NAN) type: Synchronized Cells. The wireless device 100A that is still a member of beacon group 10Y, joins to the older beacon group 10X and adopts its discovery window schedule WX. The wireless device 100A looks for beacons from other beacon groups. The wireless device 100C in the older beacon group 10X transmits a beacon 140C that is received by wireless devices 100A and 100B. The receipt of beacon 140C from device 100C triggers joining to the beacon group 10X. The MAC sets the TSF value TSF(A) of the device A equal to TSF(C), thereby causing device 100A to join the beacon group 10X. Wireless device 100A now has a TSF value of TSF(C) that is approximately equal to the value TSF(X) attributed to whole beacon group 10X and the discovery window schedule WX. Once the wireless devices 100D, 100E and 100F have received a beacon 140A from the wireless device 100A with the information about the new cell 10X, the three wireless devices 100D, 100E and 100F also synchronize their discovery window schedules to the discovery window schedule WX of the new cell 10X, in the same manner.

Whether the three wireless devices 100D, 100E and 100F also synchronize from beacon schedule perspective by moving their operations to the new cell 10X depends on whether they receive beacon frames from the new cell with strong enough signal level, in accordance with at least one embodiment of the present invention. In this example, the wireless devices 100D, 100E and 100F in beacon group 10Y are sufficiently distant from device 100C so as to not have received the beacon 140C with sufficient signal strength to justify moving to the other cell 10X.

Once devices in a cell receive information about a foreign cell from another device in their own cell, they align their discovery window schedule with the one in the foreign cell when the TSF of the foreign cell is older. Whether the devices join the foreign cell and move their operations to the foreign beacon group depends on how strongly they hear beacons from the foreign cell. Information about a foreign cell received in a beacon may trigger passive discovery in the device so that the device may check whether it should also join the foreign cell or not.

In the example embodiment of the invention described above, the cell selection is done based on the TSF value. In another example embodiment of the invention, other criteria may be used for the cell selection. For example, the beacons may be designed to contain information other than the TSF timestamp, which may be used to determine the NAN cell whose discovery window schedule is used.

FIG. 1F illustrates an example timing diagram of the Synchronized Cells NAN type network 5, wherein the wireless device 100F in the cell 10Y has received the beacon 140A from the wireless device 100A with the information 508 about the new cell 10X, and synchronizes its discovery window schedule to the discovery window schedule WX of the new cell 10X, in accordance with an example embodiment of the invention.

Wireless device 100B in the cell 10X transmits a beacon 140B after TBTT(1), which is received by wireless device 100A that is currently in cell Y, as shown in FIG. 1C. The beacon packet 140B may include the NAN ID of cell 10X, the beacon period of the new cell 10X, the timestamp TSF(B) of wireless device 100B, and the discovery window schedule WX of the cell 10X.

The wireless device 100A operates in the network 5 of synchronized cells. Since the wireless device 100A is a master device in cell 10Y in this example, the wireless device 100A transmits as a master device in the cell 10Y at least one beacon 140A that contains information about the new cell 10X, as shown in FIG. 1D. The information indicates at least the TSF value and the discovery window schedule WX of the new cell 10X. The beacon packet 140A may include the NAN ID of new cell 10X, the beacon period of the new cell 10X, the timestamp TSF(X) of the new cell 10X, and the discovery window schedule WX of the new cell 10X. Once the wireless device 100A has transmitted at least one beacon 140A in the cell 10Y with information about the new cell 10X, it may start operating in the new cell 10X, adopt its discovery window schedule WX, and cease all the operations in the old cell 10Y.

Once the wireless device 100F in the cell 10Y has received the beacon 140A from the wireless device 100A with the information about the new cell 10X, the wireless device 100F synchronizes its discovery window schedule by changing it from the existing WY to the discovery window schedule WX of the new cell 10X, as shown in FIG. 1E.

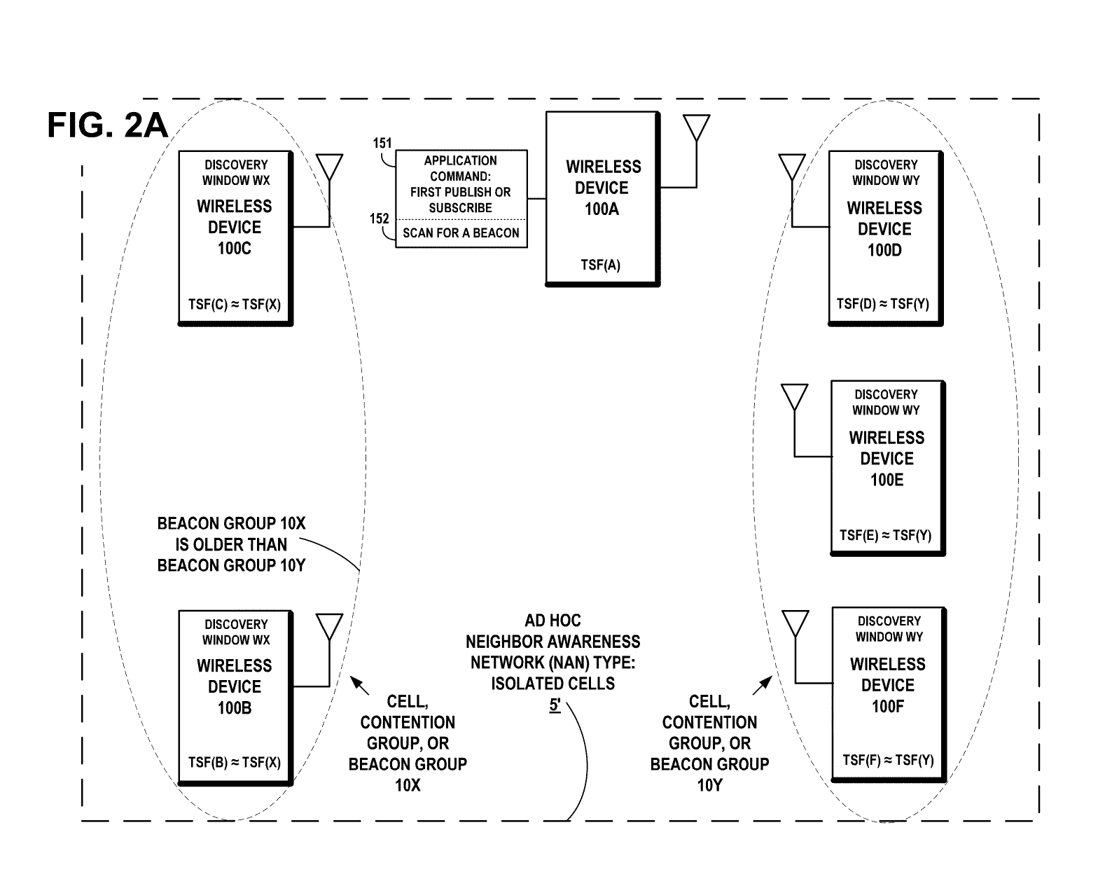

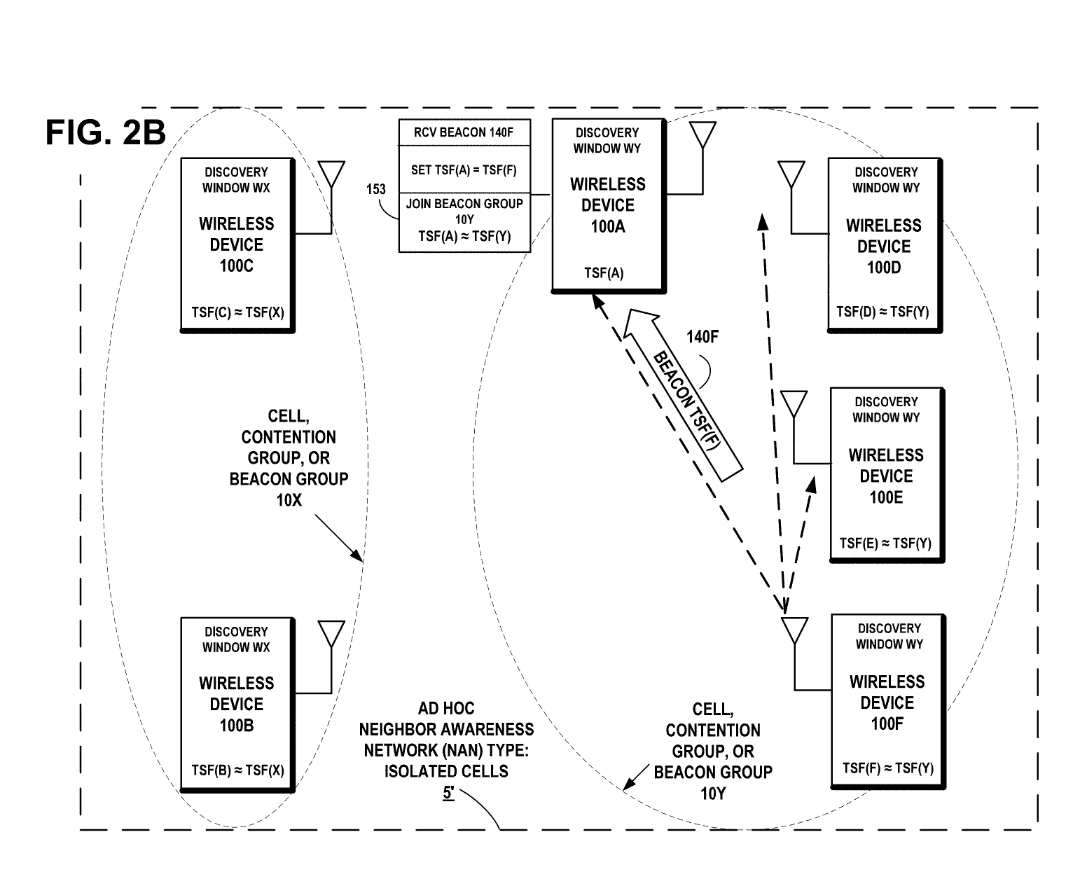

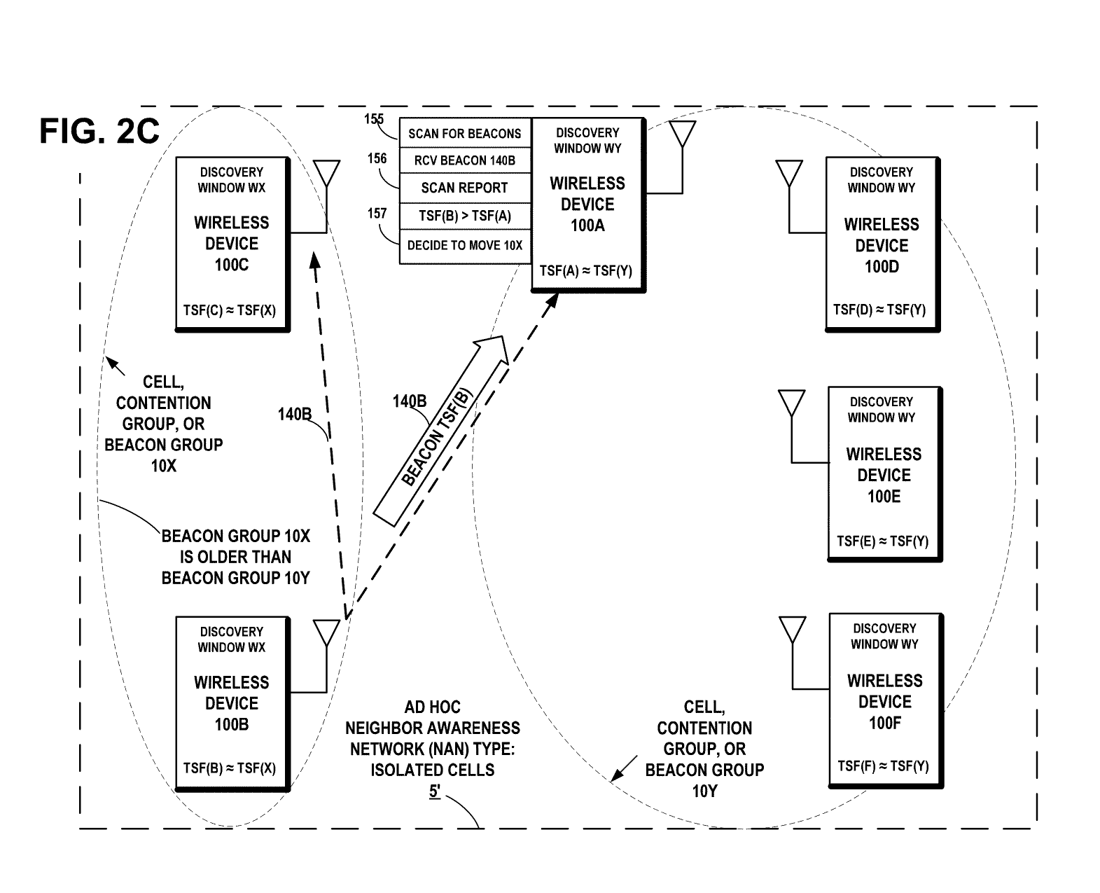

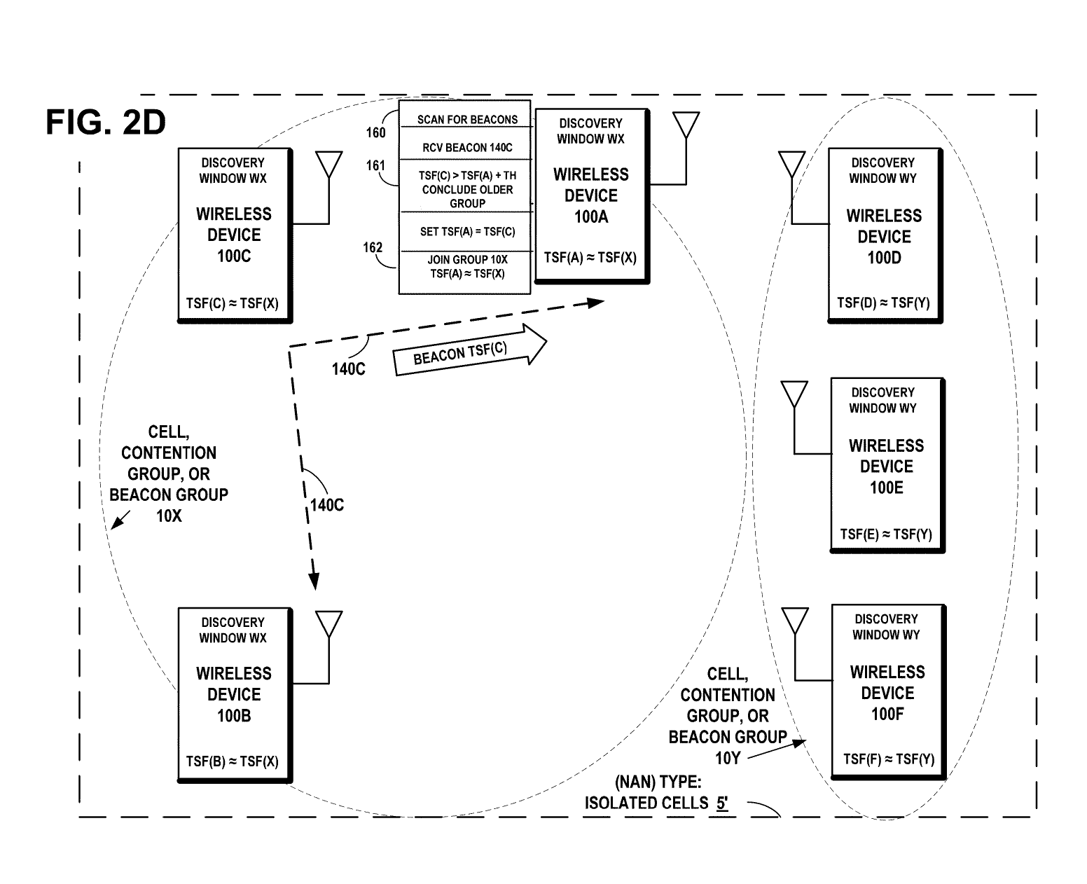

FIG. 2A illustrates an example network diagram of an ad hoc neighbor awareness network (NAN) type: Isolated Cells. The cells are also referred to as contention groups or beacon groups. The network type of Isolated Cells has schedules that are localized to each cell, with the objective to keep adjacent/overlapping cells unsynchronized, for example to enhance the confidentiality of communications between devices in the same cell. The network 5′ includes two ad hoc cells, contention groups, or beacon groups, one an older beacon group 10X that has a discovery window schedule WX and the other a younger beacon group 10Y that has a discovery window schedule WY. All wireless devices in proximity within a beacon group may communicate with each other. Beacons transmitted in the beacon groups contain NAN network identifier that indicate also the type of the network to which the beacon group belongs. An application in wireless device 100A commands the NAN Discovery Engine in the device to start either the Subscribe or the Publish service. As part of such a command the application may indicate the type of the NAN network to which the service is targeted. If the NAN Discovery Engine has no previous Subscribe or Publish service active for the requested network type and the device begins looking for beacons, in accordance with at least one embodiment of the present invention. When the command has contained an indication of the targeted network type, the device looks for beacons from NAN cells of the indicated network type. In the illustrated example case the command has been to start one of the NAN Discovery Engine services in a network of isolated cells.

FIG. 2B illustrates the example network diagram of FIG. 2A, of the ad hoc neighbor awareness network (NAN) type: Isolated Cells. The wireless device 100F in the younger beacon group 10Y transmits a beacon 140F that is received by wireless devices 100A, 100D, and 100E. The wireless device 100A sets its timing synchronization function TSF(A) to the value of TSF(F) in the received beacon 140F, adopts its discovery window schedule WY, and joins the beacon group 10Y, as indicated at 153, in accordance with at least one embodiment of the present invention.

FIG. 2C illustrates the example network diagram of FIG. 2B, of the ad hoc neighbor awareness network (NAN) type: Isolated Cells. The wireless device 100A is looking for beacons, as indicated at 155. Wireless device 100B in the older beacon group 10X transmits a beacon 140B that is received by wireless device 100A. The wireless device 100A compares its time synchronization function TSF(A), which approximates the TSF(Y) of the younger beacon group 10Y, with the value of TSF(B) in the received beacon 140B, which approximates the TSF(X) of the older beacon group 10X, and determines that the beacon group 10X is older than its existing beacon group 10Y. The wireless device 100A decides to move to the older beacon group 10X, as indicated at 157 and adopt its discovery window schedule WX, in accordance with at least one embodiment of the present invention.

FIG. 2D illustrates the example network diagram of FIG. 2C, of the ad hoc neighbor awareness network (NAN) type: Isolated Cells. When a NAN wireless device 100A operates in a network of isolated cells, then when moving its operations to a new cell 10X, regardless of whether the wireless device 100A is a master or a non-master device in the current/old cell 10Y, it starts operating in the new cell 10X and ceases all the operations in the old cell 10Y. The wireless device 100A that is still a member of beacon group 10Y, joins to the older beacon group 10X and adopts its discovery window schedule WX. The wireless device 100A looks for beacons from other beacon groups, as indicated at 160. The wireless device 100C in the older beacon group 10X transmits a beacon 140C that is received by wireless devices 100A and 100B. The receipt of beacon 140C from device 100C triggers wireless device 100A joining to the beacon group 10X. The MAC sets the TSF value TSF(A) of the device A equal to TSF(C), thereby causing device 100A to join the beacon group 10X, as indicated at 162. Wireless device 100A now has a TSF value of TSF(C) that is approximately equal to the value TSF(X) attributed to whole beacon group 10X and a discovery window schedule WX. In this example, the wireless devices 100D, 100E and 100F in beacon group 10Y are sufficiently distant from device 100C so as to not have received the beacon 140C with sufficient signal strength to justify moving to the other cell 10X. Because the network type of network 5′ is Isolated Cells, the three wireless devices 100D, 100E and 100F continue to use their existing discovery window schedule WY in their existing beacon group 10Y, in accordance with at least one embodiment of the present invention. The discovery window schedule WY of the wireless devices 100A, 100D, and 100E in the current/old cell 10Y, remains unchanged, in accordance with at least one embodiment of the present invention.

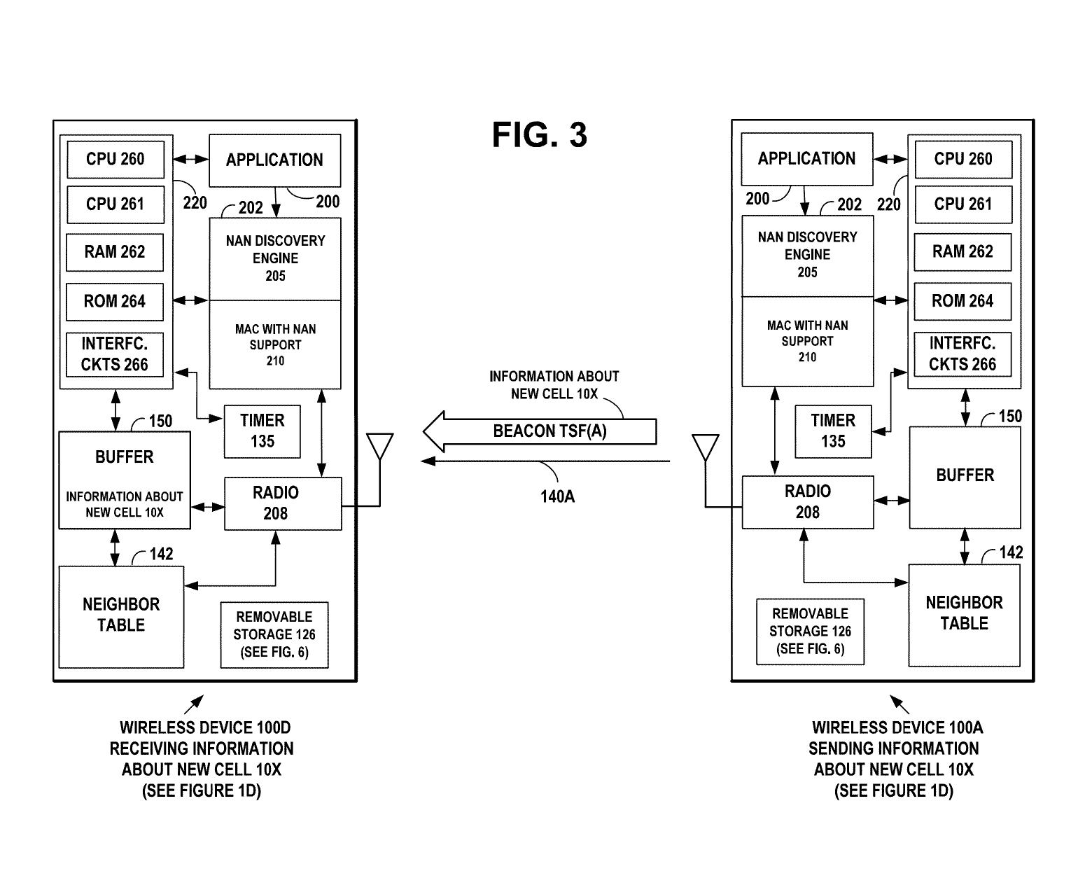

FIG. 3 may be an example functional block diagram of any of the wireless devices 100A, 100B, 100C, 100D, 100E, and 100F in FIG. 1A through FIG. 1E. For example, FIG. 3 is a functional block diagram of the wireless device 100A operating in a network of synchronized cells and moving from current/old cell 10Y to new cell 10X. When the wireless device 100A is a master device in the current/old cell 10Y, the device transmits as a master device in the current/old cell 10Y at least one sync frame 140A that contains information about the new cell 10X. Once the wireless device 100D has received the beacon 140A from the wireless device 100A with the information about the new cell 10X, the wireless device 100D may also synchronize the discovery window schedule WX it uses from the new cell 10X, in accordance with at least one embodiment of the present invention.

In an example embodiment of the invention, the wireless device 100A and the wireless device 100D may be a communications device, PDA, cell phone, laptop or palmtop computer, or the like or it may be a stationary access point, automotive dashboard interface, home electronics interface or other stationary interface or device. The wireless device 100A and the wireless device 100D may be a remote controller, healthcare monitor, sports sensor, token, key fob, watch, wireless keyboard, gaming pad, body sensor, toy, health care equipment, human interface device, entertainment device, wireless microphone, GPS sensor, or the like.

In an example embodiment of the invention, the wireless device 100A and the wireless device 100D may include a processor 220 that includes a single core or multi-core central processing unit (CPU) 260 and 261, a random access memory (RAM) 262, a read only memory (ROM) 264, and interface circuits 266 to interface with the radio transceiver 208. The wireless device 100A and the wireless device 100D may each further include a battery and other power sources, key pad, touch screen, display, microphone, speakers, ear pieces, camera or other imaging devices, etc. The RAM 262 and ROM 264 may be removable memory devices such as smart cards, SIMs, WIMs, semiconductor memories such as RAM, ROM, PROMS, flash memory devices, etc. according to an embodiment of the present invention. According to an example embodiment of the invention, the wireless device 100A and the wireless device 100D each include the awareness protocol stack 202.

In an example embodiment of the invention, the awareness protocol stack 202 may include the NAN discovery engine 205 and the MAC with NAN support 210. In an example embodiment of the invention, the awareness protocol stack 202 may include an Awareness Layer, Community Layer, Network Layer, and Link Layer.

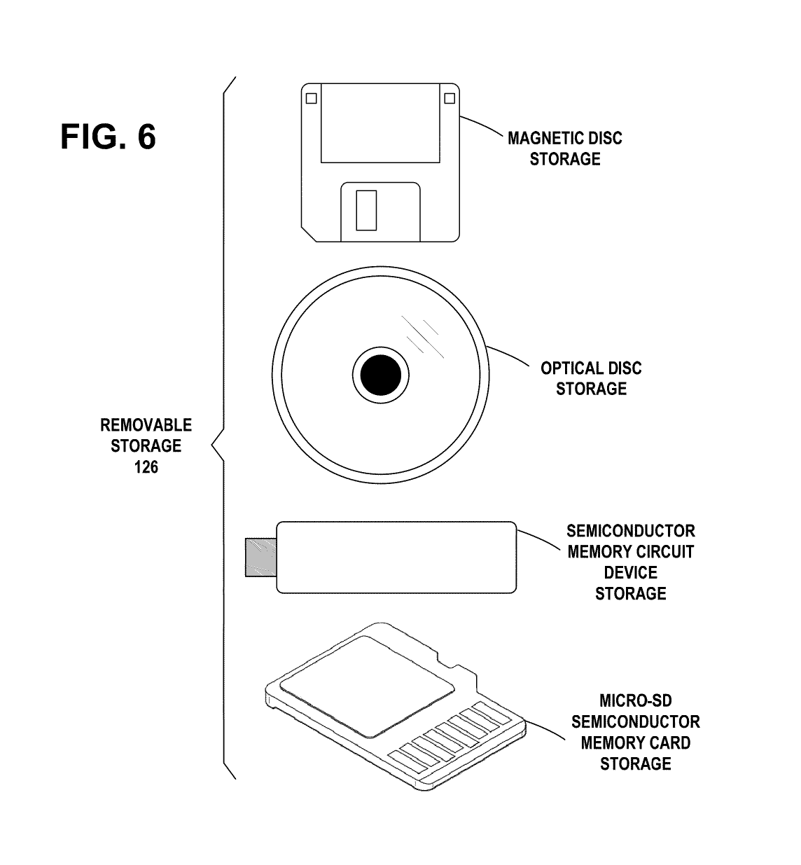

In an example embodiment of the invention, the processor 220, protocol stack 202 and/or application program 200 may be embodied as program logic stored in the RAM 262 and/or ROM 264 in the form of sequences of programmed instructions which, when executed in the CPUs 260 and/or 261, carry out the functions of the disclosed embodiments. The program logic may be delivered to the writeable RAM, PROMS, flash memory devices, etc. 262 of the wireless device 100A and the wireless device 100D from a computer program product or article of manufacture in the form of computer-usable media such as resident memory devices, smart cards or other removable memory devices, as illustrated in FIG. 6. Alternately, they may be embodied as integrated circuit logic in the form of programmed logic arrays or custom designed application specific integrated circuits (ASIC). The radio 208 in the each of the wireless device 100A and the wireless device 100D may be separate transceiver circuits or alternately, the radio 208 may be a single radio module capable of handling one or multiple channels in a high speed, time and frequency multiplexed manner in response to the processor 220. The program code for instructing the apparatus to perform its various operations may be stored in computer readable media, for example magnetic disks, CD ROMS, or flash memory devices. The program code may be downloaded from such computer readable media to be stored for example in the RAM 262 or programmable ROM 264 of the wireless device 100A and the wireless device 100D for execution of the program code for example by the CPUs 260 and/or 261. Removable storage media 126 are shown in FIG. 6.

In an example embodiment of the invention, the application program 200 executed in the processor 220, may determine a network type for the wireless communications network 5 or 5′ associated with the wireless device 100A, based on an active requirement associated with the apparatus. An example active requirement may include a need to locate desired services within communications range, using a network type comprising synchronized cells. Alternately, an active requirement may include a need for maintaining confidential communications between wireless devices, using a network type comprising isolated cells. The application program 200 executed in the processor 220 may command the protocol stack 202 to operate the wireless communications network 5 or 5′ as comprising at least one of a synchronized contention group and an isolated contention group, in response to the determined network type. In this manner, the application program 200 executed in the processor 220 may, in combination with the protocol stack 202, set up a network type for the wireless communications network 5 or 5′ associated with the wireless device 100A. This network set up operation may be performed by any of the wireless devices 100A, 100B, 100C, 100D, 100E, and 100F in network 5 of FIG. 1A through FIG. 1E or any of the wireless devices 100A, 100B, 100C, 100D, 100E, and 100F in network 5′ of FIG. 2A through FIG. 2D.

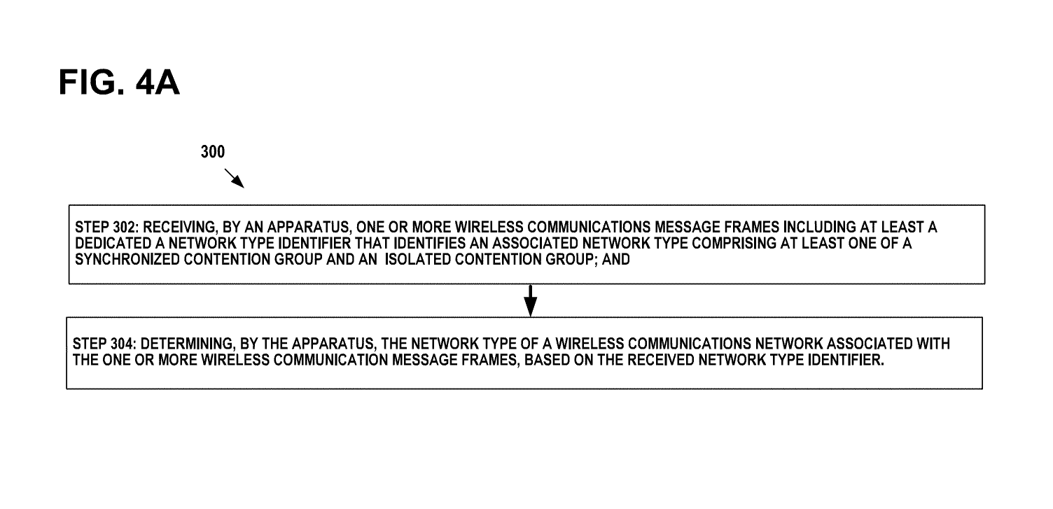

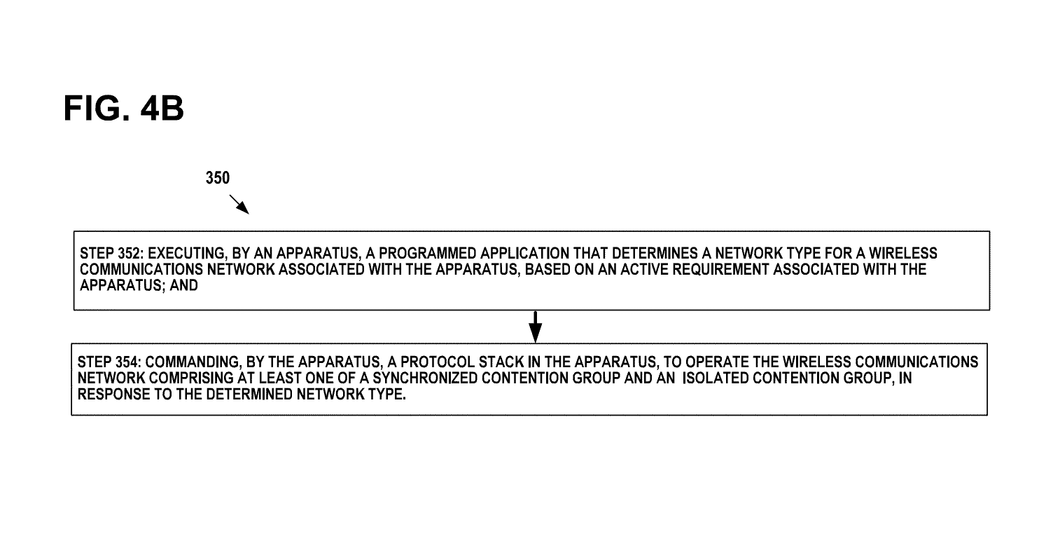

FIG. 4A is an example flow diagram 300 of operational steps in the wireless device 100A of FIG. 1A, in accordance with at least one embodiment of the present invention. The steps of the flow diagram represent computer code instructions stored in the RAM and/or ROM memory, which when executed by the central processing units (CPU) CPU1 and/or CPU2, carry out the functions of the example embodiments of the invention. The steps may be carried out in another order than shown and individual steps may be combined or separated into component steps. The flow diagram has the following steps:

Step 302: receiving, by an apparatus, one or more wireless communications message frames including at least a dedicated a network type identifier that identifies an associated network type comprising at least one of a synchronized contention group and an isolated contention group; and

Step 304: determining, by the apparatus, the network type of a wireless communications network associated with the one or more wireless communication message frames, based on the received network type identifier.

FIG. 4B is an example flow diagram 350 of operational steps in any of the wireless devices 100A, 100B, 100C, 100D, 100E, and 100F in network 5 of FIG. 1A through FIG. 1E or any of the wireless devices 100A, 100B, 100C, 100D, 100E, and 100F in network 5′ of FIG. 2A through FIG. 2D. The steps of the flow diagram represent computer code instructions stored in the RAM and/or ROM memory, which when executed by the central processing units (CPU) CPU1 and/or CPU2, carry out the functions of the example embodiments of the invention. The steps may be carried out in another order than shown and individual steps may be combined or separated into component steps. The flow diagram has the following steps:

Step 352: executing, by an apparatus, a programmed application that determines a network type for a wireless communications network associated with the apparatus, based on an active requirement associated with the apparatus; and

Step 354: commanding, by the apparatus, a protocol stack in the apparatus, to operate the wireless communications network comprising at least one of a synchronized contention group and an isolated contention group, in response to the determined network type.

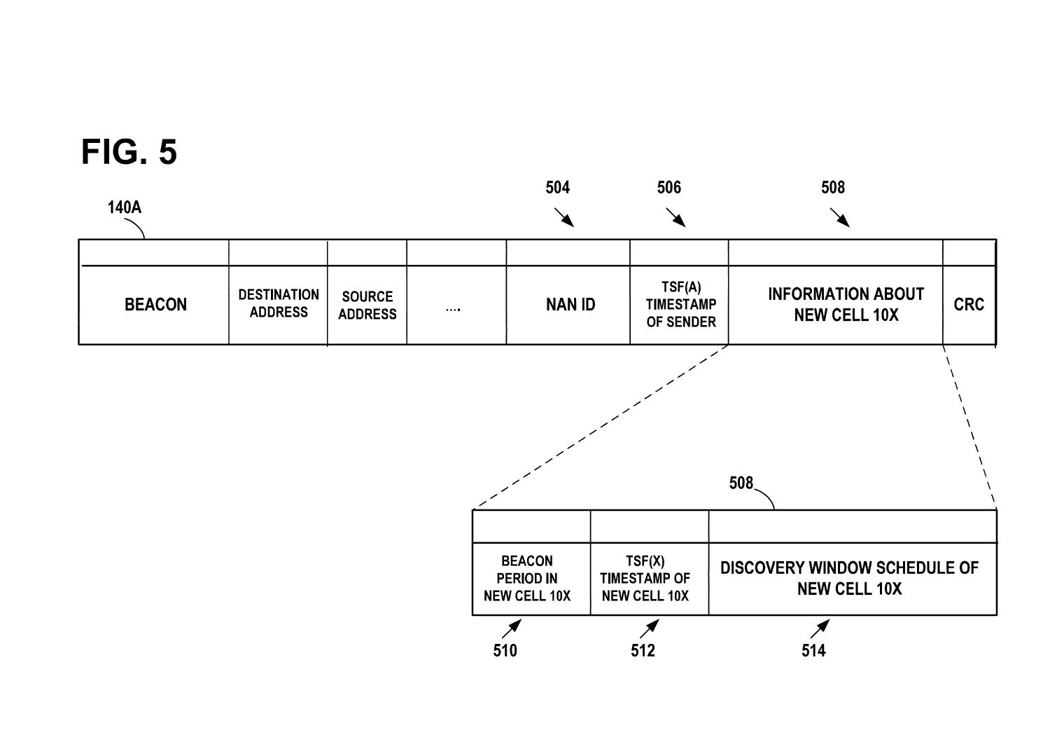

FIG. 5 shows an example format of the beacon packet 140A transmitted by wireless device 100A in FIG. 1D. The beacon packet 140A includes the field 504 for the NAN ID of the new cell 10X, the field 506 for the time stamp TSF(A) of the sending device 100A, and the field 508 for the information about the new cell 10X. The field 508 for the information about the new cell 10X includes a field 510 for the beacon period of the new cell 10X, a field 512 for the timestamp TSF(X) of the new cell 10X, and a field 514 for the discovery window schedule of the new cell 10X, in accordance with at least one embodiment of the present invention.

FIG. 6 illustrates an example embodiment of the invention, wherein examples of removable storage media 126 are shown, based on magnetic, electronic and/or optical technologies, such as magnetic disks, optical disks, semiconductor memory circuit devices and micro-SD memory cards (SD refers to the Secure Digital standard) for storing data and/or computer program code as an example computer program product, in accordance with an example embodiment of the invention.

According to an example embodiment of the invention, a computer program product comprises computer executable program code recorded on a computer readable non-transitory storage medium, the computer executable program code comprising:

code for executing, by an apparatus, a programmed application that determines a network type for a wireless communications network associated with the apparatus, based on an active requirement associated with the apparatus; and

code for commanding, by the apparatus, a protocol stack in the apparatus, to operate the wireless communications network comprising at least one of a synchronized contention group and an isolated contention group, in response to the determined network type.

Although specific example embodiments have been disclosed, a person skilled in the art will understand that changes can be made to the specific example embodiments without departing from the spirit and scope of the invention.

What is claimed is:

1. A method, comprising:
receiving, by an apparatus, one or more wireless communications message frames including at least a dedicated a network type identifier that identifies an associated network type comprising at least one of a synchronized contention group and an isolated contention group; and
determining, by the apparatus, the network type of a wireless communications network associated with the one or more wireless communication message frames, based on the received network type identifier.

2. The method of claim 1, further comprising:
wherein the determined network type of the wireless communications network comprises a synchronized contention group and the apparatus currently operates in an existing contention group of the wireless communications network;
determining, by the apparatus, that the received one or more wireless communications message frames is from a foreign contention group in the wireless communications network and that the one or more wireless communications message frames include a received time value different from a local time value in the apparatus; and
deciding, by the apparatus, to adopt the discovery window schedule of the foreign contention group based on the received time value.

3. The method of claim 2, further comprising:
transmitting, by the apparatus, one or more synchronization frames to the existing contention group, when the apparatus moves its operations to the foreign contention group, the one or more synchronization frames including information about the foreign contention group, to enable wireless devices in the existing contention group to adopt the discovery window schedule of the foreign contention group.

4. The method of claim 2, wherein when the received time value is larger than the local time value, the discovery window schedule of the foreign contention group is adopted.

5. The method of claim 1, further comprising:
wherein the determined network type of the wireless communications network comprises an isolated contention group and the apparatus currently operates in an existing contention group of the wireless communications network;
determining, by the apparatus, that the received one or more wireless communications message frames is from a foreign contention group in the wireless communications network and that the one or more wireless communications message frames include a received time value different from a local time value in the apparatus; and
deciding, by the apparatus, to adopt the discovery window schedule of the foreign contention group based on the received time value.

6. The method of claim 5, further comprising:
ceasing, by the apparatus, operations in the existing contention group of which it has been a member, and immediately starting operations in the foreign contention group when the apparatus is moving its operations to the foreign contention group.

7. A method, comprising:
executing, by an apparatus, a programmed application that determines a network type for a wireless communications network associated with the apparatus, based on an active requirement associated with the apparatus; and
commanding, by the apparatus, a protocol stack in the apparatus, to operate the wireless communications network comprising at least one of a synchronized contention group and an isolated contention group, in response to the determined network type.

8. An apparatus, comprising:
at least one processor;
at least one memory including computer program code;
the at least one memory and the computer program code configured to, with the at least one processor, cause the apparatus at least to:
receive one or more wireless communications message frames including at least a dedicated a network type identifier that identifies an associated network type comprising at least one of a synchronized contention group and an isolated contention group; and
determine the network type of a wireless communications network associated with the one or more wireless communication message frames, based on the received network type identifier.

9. The apparatus of claim 8, further comprising:
wherein the determined network type of the wireless communications network comprises a synchronized contention group and the apparatus currently operates in an existing contention group of the wireless communications network;
the at least one memory and the computer program code configured to, with the at least one processor, cause the apparatus at least to:
determine that the received one or more wireless communications message frames is from a foreign contention group in the wireless communications network and that the one or more wireless communications message frames include a received time value different from a local time value in the apparatus; and
decide to adopt the discovery window schedule of the foreign contention group based on the received time value.

10. The apparatus of claim 9, further comprising:
the at least one memory and the computer program code configured to, with the at least one processor, cause the apparatus at least to:
transmit one or more synchronization frames to the existing contention group, when the apparatus moves its operations to the foreign contention group, the one or more synchronization frames including information about the foreign contention group, to enable wireless devices in the existing contention group to adopt the discovery window schedule of the foreign contention group.

11. The apparatus of claim 9, wherein when the received time value is larger than the local time value, the discovery window schedule of the foreign contention group is adopted.

12. The apparatus of claim 8, further comprising:
wherein the determined network type of the wireless communications network comprises an isolated contention group and the apparatus currently operates in an existing contention group of the wireless communications network;
the at least one memory and the computer program code configured to, with the at least one processor, cause the apparatus at least to:
determine that the received one or more wireless communications message frames is from a foreign contention group in the wireless communications network and that the one or more wireless communications message frames include a received time value different from a local time value in the apparatus; and
decide to adopt the discovery window schedule of the foreign contention group based on the received time value.

13. The apparatus of claim 12, further comprising:
the at least one memory and the computer program code configured to, with the at least one processor, cause the apparatus at least to:
cease operations in the existing contention group of which it has been a member, and immediately starting operations in the foreign contention group when the apparatus is moving its operations to the foreign contention group.

14. An apparatus, comprising:
at least one processor;
at least one memory including computer program code;
the at least one memory and the computer program code configured to, with the at least one processor, cause the apparatus at least to:
execute a programmed application that determines a network type for a wireless communications network associated with the apparatus, based on an active requirement associated with the apparatus; and
command a protocol stack in the apparatus, to operate the wireless communications network comprising at least one of a synchronized contention group and an isolated contention group, in response to the determined network type.

15. A computer program product comprising computer executable program code recorded on a computer readable non-transitory storage medium, the computer executable program code comprising:
code for receiving, by an apparatus, one or more wireless communications message frames including at least a dedicated a network type identifier that identifies an associated network type comprising at least one of a synchronized contention group and an isolated contention group; and
code for determining, by the apparatus, the network type of a wireless communications network associated with the one or more wireless communication message frames, based on the received network type identifier.

16. The computer program product of claim 15, further comprising:
wherein the determined network type of the wireless communications network comprises a synchronized contention group and the apparatus currently operates in an existing contention group of the wireless communications network;
code for determining, by the apparatus, that the received one or more wireless communications message frames is from a foreign contention group in the wireless communications network and that the one or more wireless communications message frames include a received time value different from a local time value in the apparatus; and
code for deciding, by the apparatus, to adopt the discovery window schedule of the foreign contention group based on the received time value.

17. The computer program product of claim 16, further comprising:
code for transmitting, by the apparatus, one or more synchronization frames to the existing contention group, when the apparatus moves its operations to the foreign contention group, the one or more synchronization frames including information about the foreign contention group, to enable wireless devices in the existing contention group to adopt the discovery window schedule of the foreign contention group.

18. The computer program product of claim 16, wherein when the received time value is larger than the local time value, the discovery window schedule of the foreign contention group is adopted.

19. The computer program product of claim 15 further comprising:
wherein the determined network type of the wireless communications network comprises an isolated contention group and the apparatus currently operates in an existing contention group of the wireless communications network;
code for determining, by the apparatus, that the received one or more wireless communications message frames is from a foreign contention group in the wireless communications network and that the one or more wireless communications message frames include a received time value different from a local time value in the apparatus; and
code for deciding, by the apparatus, to adopt the discovery window schedule of the foreign contention group based on the received time value.

20. The computer program product of claim 19, further comprising:
code for ceasing, by the apparatus, operations in the existing contention group of which it has been a member, and immediately starting operations in the foreign contention group when the apparatus is moving its operations to the foreign contention group.
